(19) United States
(12) Patent Application Publication
(10) Pub. No.: US 2013/0060555 A1
(43) Pub. Date: Mar. 7, 2013

(54) System and Apparatus Modeling Processor Workloads Using Virtual Pulse Chains

(71) Applicants: Steven S. Thomson, San Diego, CA (US); Edoardo Regini, San Diego, CA (US); Mriganka Mondal, San Diego, CA (US); Nishant Hariharan, San Diego, CA (US)

(72) Inventors: Steven S. Thomson, San Diego, CA (US); Edoardo Regini, San Diego, CA (US); Mriganka Mondal, San Diego, CA (US); Nishant Hariharan, San Diego, CA (US)

(73) Assignee: QUALCOMM INCORPORATED, San Diego, CA (US)

(21) Appl. No.: 13/406,093

(22) Filed: Feb. 27, 2012

Related U.S. Application Data
(60) Provisional application No. 61/495,861, filed on Jun. 10, 2011.
(60) Provisional application No. 61/591,154, filed on Jan. 26, 2012.

(51) Int. Cl. G06F 1/08; G06G 7/62; G06F 1/12; G06F 9/44; G06F 9/46

(52) U.S. Cl. 703/21; 712/30; 712/E09.016; 718/100; 718/102; 713/501; 713/375

(57) ABSTRACT

Methods and apparatus for controlling at least two processing cores in a multi-processor device or system include accessing an operating system run queue to generate virtual pulse trains for each core and correlating the virtual pulse trains to identify patterns of interdependence. The correlated information may be used to determine dynamic frequency/voltage control settings for the first and second processing cores to provide a performance level that accommodates interdependent processes, threads and processing cores.

### RELATED APPLICATIONS

This application claims the benefit of priority to U.S. Provisional Application No. 61/495,861, entitled “System and Apparatus for Consolidated Dynamic Frequency/Voltage Control” filed Jun. 10, 2011, and U.S. Provisional Application No. 61/591,154, entitled “System and Apparatus for Modeling Processor Workloads Using Virtual Pulse Chains” filed Jan. 26, 2012, the entire contents of both of which are hereby incorporated by reference.

This application is also related to U.S. patent application Ser. No. 13/344,146 entitled “System and Apparatus for Consolidated Dynamic Frequency/Voltage Control” filed Jan. 5, 2012 which also claims the benefit of priority to U.S. Provisional Patent Application No. 61/495,861.

### BACKGROUND

Cellular and wireless communication technologies have seen explosive growth over the past several years. This growth has been fueled by better communications, hardware, larger networks, and more reliable protocols. Wireless service providers are now able to offer their customers an ever-expanding array of features and services, and provide users with unprecedented levels of access to information, resources, and communications. To keep pace with these service enhancements, mobile electronic devices (e.g., cellular phones, tablets, laptops, etc.) have become more powerful and complex than ever. For example, mobile electronic devices now commonly include system-on-chips (SoCs) and/or multiple multiprocessor cores embedded on a single substrate, allowing mobile device users to execute complex and power intensive software applications on their mobile devices. As a result, a mobile device's battery life and power consumption characteristics are becoming ever more important considerations for consumers of mobile devices.

The performance and battery life of computing devices may be improved by scheduling processes such that the workload is evenly distributed. Methods for improving the performance and battery life of computing devices may also involve reducing the frequency and/or voltage applied to a processor/core when it is idle or lightly loaded. Such reductions in frequency and/or voltage may be accomplished by scaling the voltage or frequency of a processing unit, which may include using a dynamic clock and voltage/frequency scaling (DCVS) scheme/processes. DCVS schemes allow decisions regarding the most energy efficient performance of the processor to be made in real time or “on the fly.” This may be achieved by monitoring the proportion of the time that a processor is idle (compared to the time it is busy), and determining how much the frequency/voltage of one or more processing units should be adjusted in order to balance the multiprocessor's performance and energy consumption.

Conventional scheduling and DCVS solutions are targeted toward single processor systems. Modern mobile electronic devices are multiprocessor systems, and may include system-on-chips (SoCs) and/or multiple processing cores. Applying these conventional solutions to multiprocessor systems generally results in each processing core scheduling processes and/or adjusting its frequency/voltage independent of other processor cores. These independent operations may result in a number of performance problems when implemented in multiprocessor systems, and implementing effective multiprocessor solutions that correctly schedule processes and scale the frequency/voltage for each core to maximize the overall device performance is an important and challenging design criterion.

### SUMMARY

The various aspects include methods for improving performance on a multiprocessor system having two or more processing cores, the method including accessing an operating system run queue to generate a first virtual pulse train for a first processing core and a second virtual pulse train for a second processing core, and correlating the first and second virtual pulse trains to identify an interdependence relationship between the operations of the first processing core and the operations of the second processing core. In an aspect, the method may further include scheduling threads on the first and second processor cores based on the interdependence relationship between the operations of the first processing core and the operations of the second processing core. In an aspect, the method may further include performing dynamic clock and voltage scaling operations that include scaling a frequency or voltage of the first and second processor cores according to a correlated information set when an interdependence relationship is identified between the operations of the first processing core and the operations of the second processing core based on the correlation between the first and second virtual pulse trains. In an aspect, the method may further include performing dynamic clock and voltage scaling operations that include scaling a frequency or voltage of the first and second processor cores independently when no interdependence relationship is identified between the operations of the first processing core and the operations of the second processing core based on the correlation between the first and second virtual pulse trains. In an aspect, the method may further include generating predicted processor workloads that account for all available processing resources, including both online and offline processors, based on the correlation between the first and second virtual pulse trains. In an aspect, generating predicted processor workloads may include predicting an operating load under which an offline processor would be if the offline processor were online. In an aspect, the method may further include determining whether an optimal number of processing resources are currently in use by the multiprocessor system, and determining if one or more online processors should be taken offline in response to determining that the optimal number of processing resources are not currently in use. In an aspect, the method may further include reducing a frequency of the first or second processor to zero in response to determining that one or more online processors should be taken offline. In an aspect, the method may further include determining if an optimal number of processing resources are currently in use by the multiprocessor system, and determining if one or more offline processors should be brought online in response to determining that the optimal number of processing resources are not currently in use. In an aspect, the method may further include determining an optimal operating frequency at which an offline processor should be brought online based on the predicted workloads in response to determining one or more offline processors should be brought online. In an aspect, the method may further include synchronizing the first and second virtual pulse trains in time. In an aspect, the method may further include correlating the synchronized first and second virtual pulse trains by overlaying the first virtual pulse train on the second virtual pulse train. In an aspect, a single thread executing on the multiprocessor system performs dynamic clock and voltage scaling operations. In an aspect, correlating the synchronized first and second information sets may include producing a consolidated pulse train for each of the first and the second processing cores.

Further aspects include a computing device that includes a memory and two or more processor cores coupled to the memory, in which at least one of the processor cores is configured with processor-executable instructions to cause the computing device to perform operations including accessing an operating system run queue to generate a first virtual pulse train for a first processing core and a second virtual pulse train for a second processing core, and correlating the first and second virtual pulse trains to identify an interdependence relationship between the operations of the first processing core and the operations of the second processing core. In an aspect, at least one of the processor cores may be configured with processor-executable instructions to cause the computing device to perform operations further including scheduling threads on the first and second processor cores based on the interdependence relationship between the operations of the first processing core and the operations of the second processing core. In an aspect, at least one of the processor cores may be configured with processor-executable instructions to cause the computing device to perform operations further including performing dynamic clock and voltage scaling operations that include scaling a frequency or voltage of the first and second processor cores according to a correlated information set when an interdependence relationship is identified between the operations of the first processing core and the operations of the second processing core based on the correlation between the first and second virtual pulse trains. In an aspect, at least one of the processor cores may be configured with processor-executable instructions to cause the computing device to perform operations further including performing dynamic clock and voltage scaling operations that include scaling a frequency or voltage of the first and second processor cores independently when no interdependence relationship is identified between the operations of the first processing core and the operations of the second processing core based on the correlation between the first and second virtual pulse trains. In an aspect, at least one of the processor cores may be configured with processor-executable instructions to cause the computing device to perform operations further including generating predicted processor workloads that account for all available processing resources, including both online and offline processors, based on the correlation between the first and second virtual pulse trains. In an aspect, at least one of the processor cores may be configured with processor-executable instructions such that generating predicted processor workloads may include predicting an operating load under which an offline processor would be if the offline processor were online. In an aspect, at least one of the processor cores may be configured with processor-executable instructions to cause the computing device to perform operations further including determining whether an optimal number of processing resources are currently in use by the computing device, and determining if one or more online processors should be taken offline in response to determining that the optimal number of processing resources are not currently in use. In an aspect, at least one of the processor cores may be configured with processor-executable instructions to cause the computing device to perform operations further including reducing a frequency of the first or second processor to zero in response to determining that one or more online processors should be taken offline. In an aspect, at least one of the processor cores may be configured with processor-executable instructions to cause the computing device to perform operations further including determining if an optimal number of processing resources are currently in use by the computing device, and determining if one or more offline processors should be brought online in response to determining that the optimal number of processing resources are not currently in use. In an aspect, at least one of the processor cores may be configured with processor-executable instructions to cause the computing device to perform operations further including determining an optimal operating frequency at which an offline processor should be brought online based on the predicted workloads in response to determining one or more offline processors should be brought online. In an aspect, at least one of the processor cores may be configured with processor-executable instructions to cause the computing device to perform operations further including synchronizing the first and second virtual pulse trains in time. In an aspect, at least one of the processor cores may be configured with processor-executable instructions to cause the computing device to perform operations further including correlating the synchronized first and second virtual pulse trains by overlaying the first virtual pulse train on the second virtual pulse train. In an aspect, at least one of the processor cores may be configured with processor-executable instructions such that a single thread executing on one of the processor cores performs dynamic clock and voltage scaling operations. In an aspect, at least one of the processor cores may be configured with processor-executable instructions such that correlating the synchronized first and second information sets may include producing a consolidated pulse train for each of the first and the second processing cores.

Further aspects include a computing device that includes means for accessing an operating system run queue to generate a first virtual pulse train for a first processing core and a second virtual pulse train for a second processing core, and means for correlating the first and second virtual pulse trains to identify an interdependence relationship between the operations of the first processing core and the operations of the second processing core. In an aspect, the computing device may include means for scheduling threads on the first and second processor cores based on the interdependence relationship between the operations of the first processing core and the operations of the second processing core. In an aspect, the computing device may include means for performing dynamic clock and voltage scaling operations that include scaling a frequency or voltage of the first and second processor cores according to a correlated information set when an interdependence relationship is identified between the operations of the first processing core and the operations of the second processing core based on the correlation between the first and second virtual pulse trains. In an aspect, the computing device may include means for performing dynamic clock and voltage scaling operations that include scaling a frequency or voltage of the first and second processor cores independently when no interdependence relationship is identified between the operations of the first processing core and the operations of the second processing core based on the correlation between the first and second virtual pulse trains. In an aspect, the computing device may include means for generating predicted processor workloads that account for all available processing resources, including both online and offline processors, based on the correlation between the first and second virtual pulse trains. In an aspect, means for generating predicted processor workloads may include means for predicting an operating load under which an offline processor would be if the offline processor were online. In an aspect, the computing device may include means for determining whether an optimal number of processing resources are currently in use by the computing device, and means for determining if one or more online processors should be taken offline in response to determining that the optimal number of processing resources are not currently in use. In an aspect, the computing device may include means for reducing a frequency of the first or second processor to zero in response to determining that one or more online processors should be taken offline. In an aspect, the computing device may include means for determining if an optimal number of processing resources are currently in use by the computing device, and means for determining if one or more offline processors should be brought online in response to determining that the optimal number of processing resources are not currently in use. In an aspect, the computing device may include means for determining an optimal operating frequency at which an offline processor should be brought online based on the predicted workloads in response to determining one or more offline processors should be brought online. In an aspect, the computing device may include means for synchronizing the first and second virtual pulse trains in time. In an aspect, the computing device may include means for correlating the synchronized first and second virtual pulse trains by overlaying the first virtual pulse train on the second virtual pulse train. In an aspect, the computing device may include means for performing dynamic clock and voltage scaling operations on a single thread executing on a processor of the computing device. In an aspect, the means for correlating the synchronized first and second information sets may include means for producing a consolidated pulse train for each of the first and the second processing cores.

Further aspects include a non-transitory processor-readable storage medium having stored thereon processor-executable software instructions configured to cause a processor to perform operations for improving performance on a multiprocessor system having two or more processing cores. In an aspect, the stored processor-executable software instructions may be configured to cause a processor to perform operations including accessing an operating system run queue to generate a first virtual pulse train for a first processing core and a second virtual pulse train for a second processing core, and correlating the first and second virtual pulse trains to identify an interdependence relationship between the operations of the first processing core and the operations of the second processing core. In an aspect, the stored processor-executable software instructions may be configured to cause a processor to perform operations further including scheduling threads on the first and second processor cores based on the interdependence relationship between the operations of the first processing core and the operations of the second processing core. In an aspect, the stored processor-executable software instructions may be configured to cause a processor to perform operations further including performing dynamic clock and voltage scaling operations that include scaling a frequency or voltage of the first and second processor cores according to a correlated information set when an interdependence relationship is identified between the operations of the first processing core and the operations of the second processing core based on the correlation between the first and second virtual pulse trains. In an aspect, the stored processor-executable software instructions may be configured to cause a processor to perform operations further including performing dynamic clock and voltage scaling operations that include scaling a frequency or voltage of the first and second processor cores independently when no interdependence relationship is identified between the operations of the first processing core and the operations of the second processing core based on the correlation between the first and second virtual pulse trains. In an aspect, the stored processor-executable software instructions may be configured to cause a processor to perform operations further including generating predicted processor workloads that account for all available processing resources, including both online and offline processors, based on the correlation between the first and second virtual pulse trains. In an aspect, the stored processor-executable software instructions may be configured to cause at least one processor core to perform operations such that generating predicted processor workloads may include predicting an operating load under which an offline processor would be if the offline processor were online. In an aspect, the stored processor-executable software instructions may be configured to cause a processor to perform operations further including determining whether an optimal number of processing resources are currently in use by the multiprocessor system, and determining if one or more online processors should be taken offline in response to determining that the optimal number of processing resources are not currently in use. In an aspect, the stored processor-executable software instructions may be configured to cause a processor to perform operations further including reducing a frequency of the first or second processor to zero in response to determining that one or more online processors should be taken offline. In an aspect, the stored processor-executable software instructions may be configured to cause a processor to perform operations further including determining if an optimal number of processing resources are currently in use by the multiprocessor system, and determining if one or more offline processors should be brought online in response to determining that the optimal number of processing resources are not currently in use. In an aspect, the stored processor-executable software instructions may be configured to cause a processor to perform operations further including determining an optimal operating frequency at which an offline processor should be brought online based on the predicted workloads in response to determining one or more offline processors should be brought online. In an aspect, the stored processor-executable software instructions may be configured to cause a processor to perform operations further including synchronizing the first and second virtual pulse trains in time. In an aspect, the stored processor-executable software instructions may be configured to cause a processor to perform operations further including correlating the synchronized first and second virtual pulse trains by overlaying the first virtual pulse train on the second virtual pulse train. In an aspect, the stored processor-executable software instructions may be configured to cause at least one processor core to perform operations such that a single thread executing on the multiprocessor system performs dynamic clock and voltage scaling operations. In an aspect, the stored processor-executable software instructions may be configured to cause at least one processor core to perform operations such that correlating the synchronized first and second information sets may include producing a consolidated pulse train for each of the first and the second processing cores.

### BRIEF DESCRIPTION OF THE DRAWINGS

The accompanying drawings, which are incorporated herein and constitute part of this specification, illustrate exemplary aspects of the invention, and together with the general description given above and the detailed description given below, serve to explain the features of the invention.

FIG. 1 is an architectural diagram of an example system on chip suitable for implementing the various aspects.

FIG. 2 is an architectural diagram of an example multicore processor suitable for implementing the various aspects.

FIG. 3 is a block diagram of a controller having multiple cores suitable for use in an aspect.

FIG. 4 is a communication flow diagram illustrating communications and processes among a driver and a number of processing cores for using virtual pulse trains to set performance levels for each processor core according to an aspect.

FIG. 5 is chart illustrating an example relationship between run queue depth and the activities of processing cores that may be implemented by the various aspects.

FIG. 6 is a performance graph illustrating the steady state and actual performance of a multiprocessor system that uses virtual pulse trains according to the various aspects.

FIGS. 7A-B are process flow diagrams of aspect methods implementable on any of a plurality of processor cores for determining an appropriate number of cores and the frequency/voltage settings of the cores based on virtual pulse trains.

FIGS. 8A-B illustrate processor virtual pulse trains used to simulate busy, idle, and wait periods along a common time reference.

FIGS. 9-12 illustrate pulse trains that may be generated based on the run queue depth for the offline cores and changes in idle enter/exit state for online cores along a common time reference.

FIGS. 13-14 illustrate relationships between pulse lengths and the run queue depth on a N-core multiprocessor system.

FIG. 15 is a component block diagram of a mobile device suitable for use in an aspect.

FIG. 16 is a component block diagram of a server device suitable for use in an aspect.

FIG. 17 is a component block diagram of a laptop computer device suitable for use in an aspect.

### DETAILED DESCRIPTION

The various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The terms “mobile device” and “computing device” are used interchangeably herein to refer to any one or all of cellular telephones, smartphones, personal or mobile multi-media players, personal data assistants (PDA's), laptop computers, tablet computers, smartbooks, ultrabooks, palm-top computers, wireless electronic mail receivers, multimedia Internet enabled cellular telephones, wireless gaming controllers, and similar personal electronic devices which include a memory, a programmable processor for which performance is important, and operate under battery power such that power conservation methods are of benefit. While the various aspects are particularly useful for mobile computing devices, such as smartphones, which have limited resources and run on battery, the aspects are generally useful in any electronic device that includes a processor and executes application programs.

Computer program code or “program code” for execution on a programmable processor for carrying out operations of the various aspects may be written in a high level programming language such as C, C++, C#, JAVA, Smalltalk, JavaScript, J++, Visual Basic, TSQL, Perl, or in various other programming languages. Programs for some target processor architecture may also be written directly in the native assembler language. A native assembler program uses instruction mnemonic representations of machine level binary instructions. Program code or programs stored on a computer readable storage medium as used herein refers to machine language code such as object code whose format is understandable by a processor.

Many kernels are organized into user space (where non-privileged code runs) and kernel space (where privileged code runs). This separation is of particular importance in Android and other general public license (GPL) environments where code that is part of the kernel space must be GPL licensed, while code running in user-space doesn't need to be GPL licensed.

The term “multiprocessor” is used herein to refer to a system or device that includes two or more processing units configured to read and execute program instructions.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (DSP, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “multicore processor” is used herein to refer to a single integrated circuit (IC) chip or chip package that contains two or more independent processing cores (e.g., CPU cores) configured to read and execute program instructions. A SOC may include multiple multicore processors, and each processor in an SOC may be referred to as a core.

The term “resource” is used herein to refer to any of a wide variety of circuits (e.g., ports, clocks, buses, oscillators, etc.), components (e.g., memory), signals (e.g., clock signals), and voltages (e.g., voltage rails) which are used to support processors and clients running on a computing device.

Generally, the dynamic power (switching power) dissipated by a chip is C*V²*f, where C is the capacitance being switched per clock cycle, V is voltage, and f is the switching frequency. Thus, as frequency changes, the dynamic power will change linearly with it. Dynamic power may account for approximately two-thirds of the total chip power. Voltage scaling may be accomplished in conjunction with frequency scaling, as the frequency that a chip runs at may be related to the operating voltage. The efficiency of some electrical components, such as voltage regulators, may decrease with increasing temperature such that the power used increases with temperature. Since increasing power use may increase the temperature, increases in voltage or frequency may increase system power demands even further.

As mentioned above, methods for improving the battery life of computing devices generally involve reducing the frequency and/or voltage applied to a processor/core when it is idle or lightly loaded. Such reductions in frequency and/or voltage may be accomplished by scaling the voltage or frequency of a processing unit, which may include using a dynamic clock and voltage/frequency scaling (DCVS) scheme/processes. DCVS schemes allow decisions regarding the most energy efficient performance of the processor to be made in real time or “on the fly.” This may be achieved by monitoring the proportion of the time that a processor is idle (compared to the time it is busy), and determining how much the frequency/voltage of one or more processing units should be adjusted in order to balance the multiprocessor's performance and energy consumption.

Conventional DCVS solutions are targeted toward single processor systems. Modern mobile electronic devices are multiprocessor systems, and may include system-on-chips (SoCs) and/or multiple processing cores. Applying conventional DCVS solutions to these multiprocessor systems generally results in each processing core adjusting its frequency/voltage independent of other processor cores. This independent application of DCVS to the cores may result in a number of performance problems when implemented in multiprocessor systems, and implementing effective multiprocessor DCVS solutions that correctly scale the frequency/voltage for each core to maximize the overall device performance is an important and challenging design criterion.

In multiprocessor systems, it is common for a single thread to be processed by a first processor core, then by a second processor core, and then again by the first processor core. It is also common results of one thread in a first processing core to trigger operations in another thread in a second processing core. In these situations, each processing core may alternatively enter an idle state while it awaits the results of processing from the other processing core. During these wait periods, each processing core may appear to be underutilized or idle, when in fact the core is simply waiting for another core to finish its operations.

If a DCVS scheme considers only the busy and idle conditions of individual cores, it may determine that a waiting core is idle a significant portion of the time, and in an attempt to reduce power consumption, cause the waiting processing core to enter a lower frequency/voltage state. This reduces the speed at which the waiting processor will perform its operations after exiting the wait sate (i.e., when the other processor completes its operations). Since the other cores may be dependent on the results generated by the now-active processor, this increase in processing time may cause the dependent cores to remain in the wait state for longer periods of time, which may in turn cause their respective DCVS schemes to reduce their operating speeds (i.e., via a reduction in frequency/voltage). This process may continue until the processing speeds of all the processing cores are significantly reduced, causing the system to appear non-responsive or slow. That is, even though the multiprocessing system may be busy as a whole, conventional DCVS schemes may incorrectly conclude that the some of the cores should be operated at lower frequency/voltage state than is optimal for running the currently active threads, causing the computing device to appear non-responsive or slow.

As discussed above, existing DCVS solutions may cause the multicore processor system to mischaracterize the processor workloads and incorrectly adjust the frequency/voltage of the cores, causing a multicore processor to exhibit poor performance in some operating situations. To overcome these problems, improved DCVS methods may be implemented that correlate the processing workloads of two or more cores and scale the frequency and/or voltage of the cores to an optimal level. One such method that correlates the processor workloads is discussed in U.S. patent application Ser. No. 13/344,146 entitled “System and Apparatus for Consolidated Dynamic Frequency/Voltage Control” filed on Jan. 5, 2012, the entire content of which is incorporated by reference.

Briefly, U.S. patent application Ser. No. 13/344,146 teaches that the above-mentioned problems with conventional DCVS mechanisms may be overcome by utilizing a single threaded DCVS application that simultaneously monitors the various cores, creates pulse trains, and correlates the pulse trains in order to determine an appropriate operating voltage/frequency for each core. These pulse trains may be generated by monitoring/sampling the busy and/or idle states (or the transitions between states) of the processing cores. However, on multiprocessor systems, each core may become idle or power collapsed at any time, causing the operating system scheduler to determine that the idle/power collapsed processor is “offline” and not schedule any work for that processor. During these periods in which no work is scheduled, the offline processor does not generate any measurable busy/idle state information that may be used to generate pulse trains. As a result, identifying correlations between processor operations by monitoring busy/idle cycles (i.e., actual pulse trains) may result in a correlation calculation that does not properly account for all the available processing resources (e.g., both the online and offline processors).

The various aspects identify correlations between processor operations using virtual pulse chains, which may be generated from monitoring the depth of one or more processor run-queues (as opposed to the busy-idle cycles). The various aspects may use these correlations to generate predicted processor workloads that account for all the available processing resources, including both online and offline processors. Various aspects may predict how busy an offline processor would be if the processor were online, and from this information generate a virtual pulse train for that processor.

Various aspects enable threads to be scheduled across multiple cores using correlations between processor workloads, which may be determined based on the virtual pulse trains that take into account all the processing resources, including both the online and offline processors. Using the virtual pulse trains, various aspects may determine if an optimal number of processors are currently being used, if one or more offline processors should be energized (or otherwise brought online), and/or if additional processors should be power collapsed or taken offline.

Various aspects may use predicted processor workloads (generated based on the virtual pulse trains) to determine an optimal frequency and/or voltage for one or more of the processors. In an aspect, if it is determined that a processor should be brought online, the predicted workloads may be used to determine an optimal operating frequency at which the offline processor should be brought online.

As mentioned above, DCVS schemes may be driven based on busy/idle transitions of the CPUs, which may be accomplished via hooks into the CPU idle threads of each CPU. In an aspect, instead of using hooks into the CPU idle threads, the system may use the run-queue depth to drive the DCVS operations. For example, the system may generate “idle-stats” pulse trains based on changes to the run-queue depth, and use the generated pulse trains to drive the DCVS scheme. In an aspect, the run-queue depth change may be used as a proxy for the busy/idle transition for each CPU. In an aspect, the system may be configured such that a CPU busy mapped to the run queue depth may be greater than the number of CPUs. In an aspect, the DCVS algorithm may be extended to allow for dropping CPU frequency to zero for certain CPUs (e.g., CPU 1 through CPU 3).

Various aspects eliminate the need for a run queue (RQ) statistics driver and/or the need to poll for the run queue depth. Various aspects apply performance guarantees to multiprocessor decisions and/or may be implemented as a seamless extension to a DCVS algorithm.

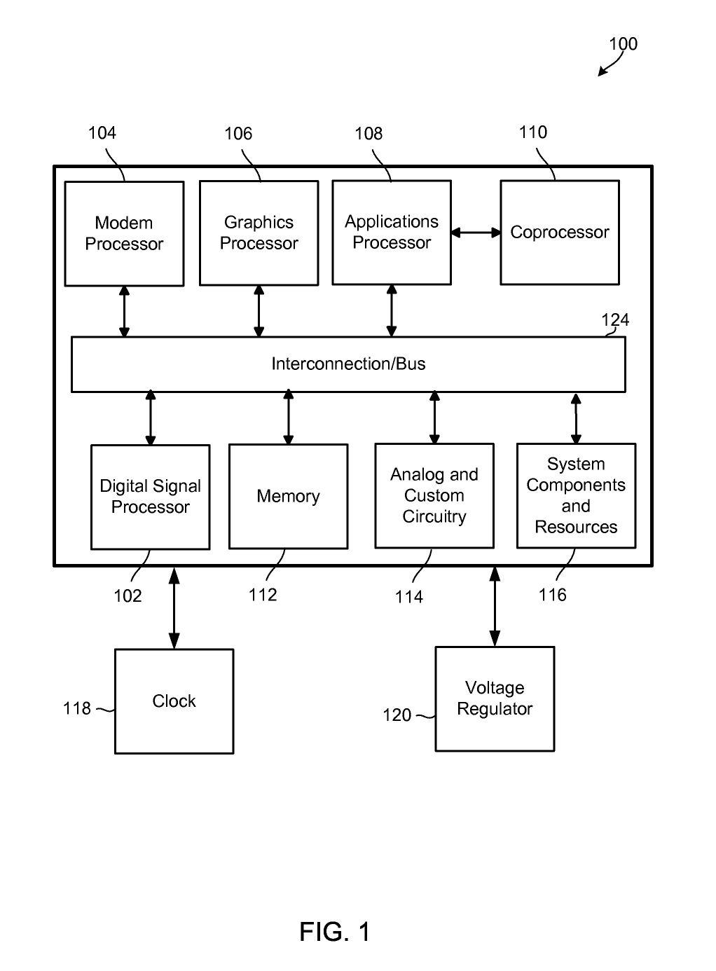

The various aspects may be implemented on a number of multicore and multiprocessor systems, including a system-on-chip (SOC). FIG. 1 is an architectural diagram illustrating an example system-on-chip (SOC) 100 architecture that may be used to implement the various aspects. The SOC 100 may include a number of heterogeneous processors, such as a digital signal processor (DSP) 102, a modem processor 104, a graphics processor 106, and an application processor 108. The SOC 100 may also include one or more coprocessors 110 (e.g., vector co-processor) connected to one or more of the processors 102, 104, 106, 108. Each processor 102, 104, 106, 108, 110 may include one or more cores, and each processor/core may perform operations independent of the other processors/cores. For example, the SOC 100 may include a processor that executes a first type of operating system (e.g., FreeBSD, LINIX, OS X, etc.) and a processor that executes a second type of operating system (e.g., Microsoft Windows 7).

The SOC 100 may also include analog circuitry and custom circuitry 114 for managing sensor data, analog-to-digital conversions, wireless data transmissions, and for performing other specialized operations, such as processing encoded audio signals for games and movies. The SOC 100 may further include system components and resources 116, such as voltage regulators, oscillators, phase-locked loops, peripheral bridges, data controllers, memory controllers, system controllers, access ports, timers, and other similar components used to support the processors and clients running on a computing device.

The system components 116 and custom circuitry 114 may include circuitry to interface with peripheral devices, such as cameras, electronic displays, wireless communication devices, external memory chips, etc. The processors 102, 104, 106, 108 may be interconnected to one or more memory elements 112, system components, and resources 116 and custom circuitry 114 via an interconnection/bus module 124, which may include an array of reconfigurable logic gates and/or implement a bus architecture (e.g., CoreConnect, AMBA, etc.). Communications may be provided by advanced interconnects, such as high performance networks-on chip (NoCs).

The SOC 100 may further include an input/output module (not illustrated) for communicating with resources external to the SOC, such as a clock 118 and a voltage regulator 120. Resources external to the SOC (e.g., clock 118, voltage regulator 120) may be shared by two or more of the internal SOC processors/cores (e.g., DSP 102, modem processor 104, graphics processor 106, applications processor 108, etc.).

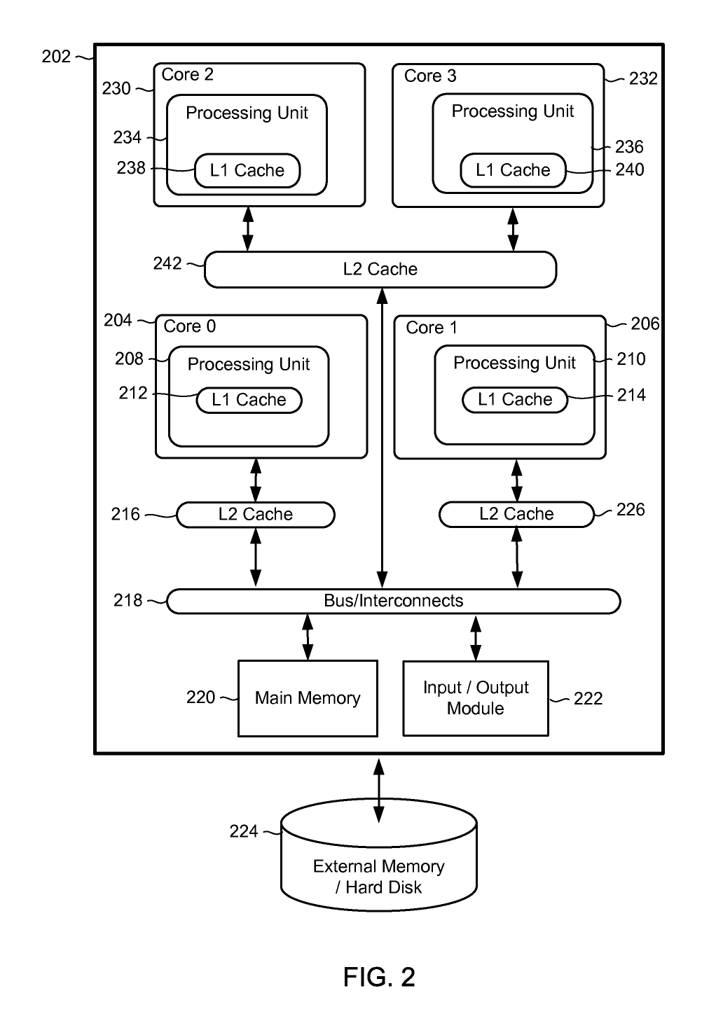

FIG. 2 is an architectural diagram illustrating an example multicore processor architecture that may be used to implement the various aspects. The multicore processor 202 may include two or more independent processing cores 204, 206, 230, 232 in close proximity (e.g., on a single substrate, die, integrated chip, etc.). The proximity of the processors/cores allows memory to operate at a much higher frequency/clock-rate than is possible if the signals have to travel off-chip. Moreover, the proximity of the cores allows for the sharing of on-chip memory and resources (e.g., voltage rail), as well as for more coordinated cooperation between cores.

The multicore processor 202 may include a multi-level cache that includes Level 1 (L1) caches 212, 214, 238, 240 and Level 2 (L2) caches 216, 226, 242. The multicore processor 202 may also include a bus/interconnect interface 218, a main memory 220, and an input/output module 222. The L2 caches 216, 226, 242 may be larger (and slower) than the L1 caches 212, 214,238, 240, but smaller (and substantially faster) than a main memory unit 220. Each processing core 204, 206, 230, 232 may include a processing unit 208, 210, 234, 236 that has private access to an L1 cache 212, 214, 238, 240. The processing cores 204, 206, 230, 232 may share access to an L2 cache (e.g., L2 cache 242) or may have access to an independent L2 cache (e.g., L2 cache 216, 226).

The L1 and L2 caches may be used to store data frequently accessed by the processing units, whereas the main memory 220 may be used to store larger files and data units being accessed by the processing cores 204, 206, 230, 232. The multicore processor 202 may be configured such that the processing cores 204, 206, 230, 232 seek data from memory in order, first querying the L1 cache, then L2 cache, and then the main memory if the information is not stored in the caches. If the information is not stored in the caches or the main memory 220, multicore processor 202 may seek information from an external memory and/or a hard disk memory 224.

The processing cores 204, 206, 230, 232 may communicate with each other via a bus/interconnect 218. Each processing core 204, 206, 230, 232 may have exclusive control over some resources and share other resources with the other cores.

The processing cores 204, 206, 230, 232 may be identical to one another, be heterogeneous, and/or implement different specialized functions. Thus, processing cores 204, 206, 230, 232 need not be symmetric, either from the operating system perspective (e.g., may execute different operating systems) or from the hardware perspective (e.g., may implement different instruction sets/architectures).

Multiprocessor hardware designs, such as those discussed above with reference to FIGS. 1 and 2, may include multiple processing cores of different capabilities inside the same package, often on the same piece of silicon. Symmetric multiprocessing hardware includes two or more identical processors connected to a single shared main memory that are controlled by a single operating system. Asymmetric or “loosely-coupled” multiprocessing hardware may include two or more heterogeneous processors/cores that may each be controlled by an independent operating system and connected to one or more shared memories/resources.

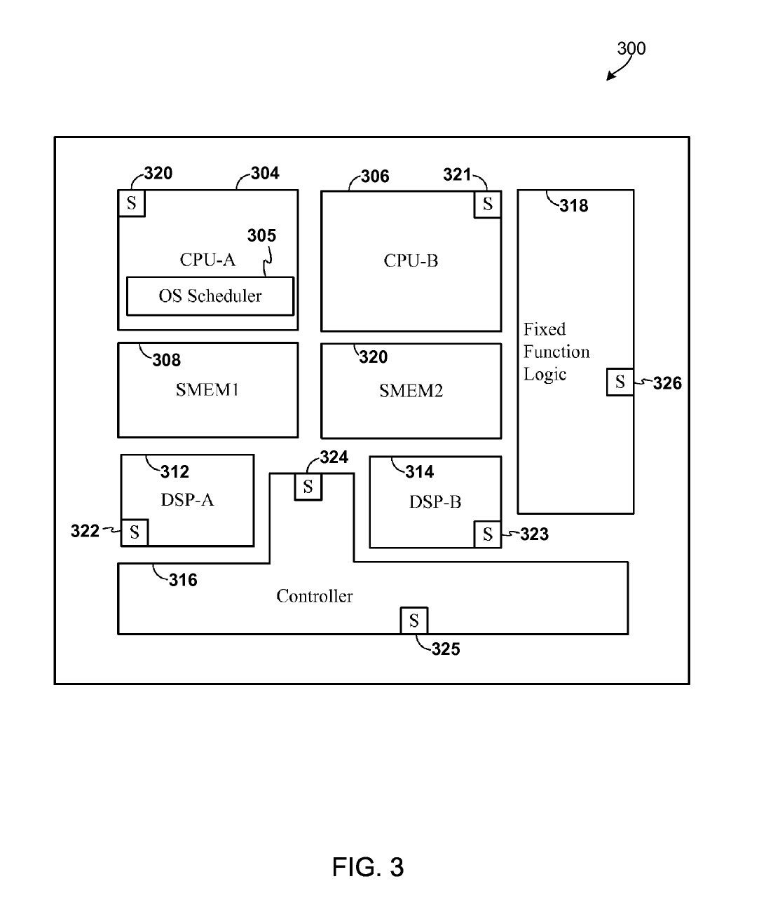

FIG. 3 illustrates an exemplary asymmetric multi-core processor system on a chip (SoC) 300 that illustrates a multi-core processor configuration suitable for implementation with the various aspects. The illustrated example multi-core processor 300 includes a first central processing unit A (CPU-A) 304, a second central processing unit (CPU-B) 306, a first shared memory (SMEM-1) 308, a second shared memory (SMEM-2) 310, a first digital signal processor (DSP-A) 312, a second digital signal processor (DSP-B) 314, a controller 316, fixed function logic 318 and sensors 320-326. The sensors 320-326 may be configured to monitor conditions that may affect task assignments on the various processing cores, such as CPU-A 304, CPU-B 306, DSP-A 312, and DSP-B 314, and which may affect operation on the controller 316 and fixed function logic 318. An operating system (OS) scheduler 305 may operate on one or more of the processors in the multi-core processor system. The scheduler 305 may schedule tasks to run on the processors based on the relative power and performance curves of the multiprocessor system across the process, voltage, temperature (PVT) operating space, as described in more detail below.

Each of the cores may be designed for different manufacturing processes. For example, core-A may be manufactured primarily with a low voltage threshold (lo-Vt) transistor process to achieve high performance, but at a cost of increased leakage current, where as core-B may be manufactured primarily with a high threshold (hi-Vt) transistor process to achieve good performance with low leakage current. As another example, each of the cores may be manufactured with a mix of hi-Vt and lo-Vt transistors (e.g., using the lo-Vt transistors in timing critical path circuits, etc.).

In addition to the processors on the same chip, the various aspects may also be applied to processors on other chips (not shown), such as CPU, a wireless modem processor, a global positioning system (GPS) receiver chip, and a graphics processor unit (GPU), which may be coupled to the multi-core processor 300. Various configurations are possible and within the scope of the present disclosure. In an aspect, the chip 300 may form part of a mobile computing device, such as a cellular telephone or smartphone.

The various aspects provide improved methods, systems, and devices for conserving power and improving performance in multiprocessor systems, such as multicore processors and systems-on-chip. The inclusion of multiple independent cores on a single chip, and the sharing of memory, resources, and power architecture between cores, gives rise to a number of power management issues not present in more distributed multiprocessing systems. Thus, a different set of design constraints may apply when designing power management and voltage/frequency scaling strategies for multicore processors and systems-on-chip than for other more distributed multiprocessing systems.

As discussed above, existing DCVS solutions may cause the multicore processor system to mischaracterize the processor workloads and incorrectly adjust the frequency/voltage of the cores, causing a multiprocessor device to exhibit poor performance in some operating situations. For example, if a single thread is shared amongst two processing cores (e.g., a CPU and a GPU), each core may appear to the system as operating at 50% of its capacity. Existing DCVS implementations may view such cores as being underutilized and/or as having too much voltage allocated to them. However, in actuality, these cores may be performing operations in cooperation with one another (i.e., cores are not actually underutilized), and the perceived idle times may be wait, hold, and/or resource access times.

In the above-mentioned situations, conventional DCVS implementations may improperly reduce the frequency/voltage of the cooperating processors. Since reducing the frequency/voltage of these processors does not result in the cores appearing any more busy/utilized (i.e., the cores are still bound by the wait/hold times and will continue to appear as operating at 50% capacity), existing DCVS implementations may further reduce the frequency/voltage of the processors until the system slows to a halt or reaches a minimum operating state.

A consolidated DCVS scheme may overcome these limitations by evaluating the performance of each online (e.g., active, running, etc.) processing core to determine if there exists a correlation between the operations of two or more cores, and scaling the frequency/voltage of an individual core only when there is no identifiable correlation between the processor operations (e.g., when the processor is not cooperatively processing a task with another processor).

The consolidated DCVS scheme may calculate the correlations based on measured busy/idle cycles (i.e., via actual pulse trains), based on the run queue depth (i.e., via virtual pulse trains), or a combination thereof, allowing the consolidated DCVS scheme to identify the correlations in a manner that allows the system to account for all the processing resources, including both the online and offline processors.

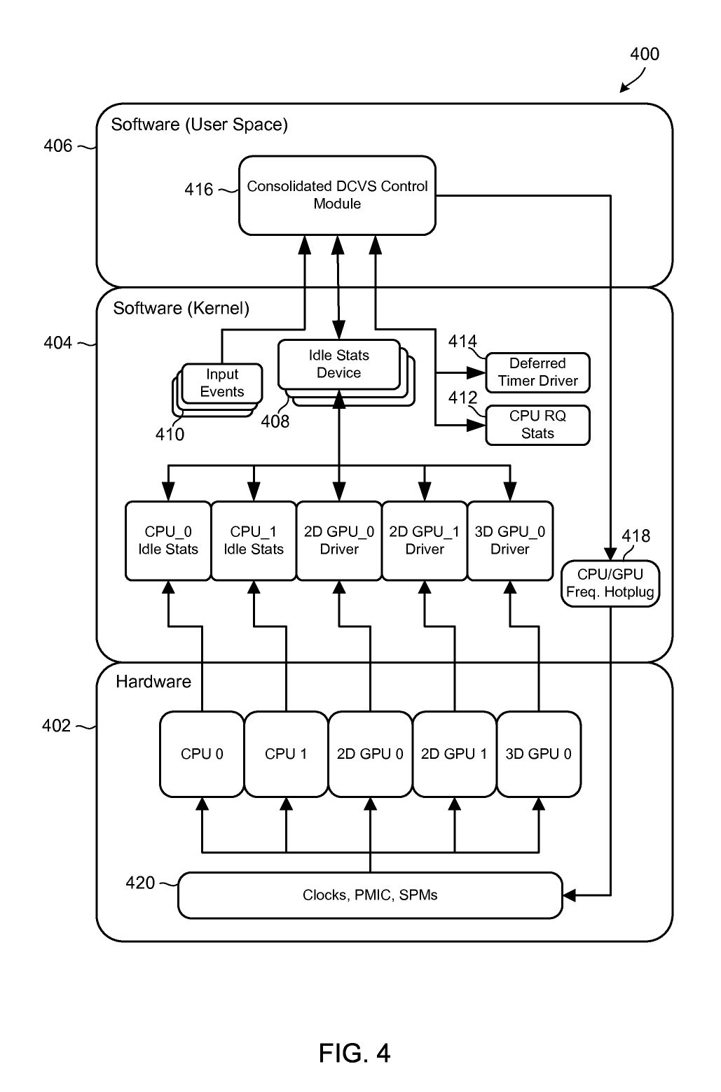

FIG. 4 illustrates logical components and information flows in a computing device 400 implementing a consolidated dynamic clock frequency/voltage scaling (DCVS) scheme in accordance with an aspect. The computing device 400 may include a hardware unit 402, a kernel software unit 404, and a user space software unit 406. The hardware unit 402 may include a number of processors/cores (e.g., CPU 0, CPU 1, 2D-GPU 0, 2D-GPU 1, 3D-GPU 0, etc.), and a resources module 420 that includes hardware resources (e.g., clocks, power management integrated circuits (PMIC), scratchpad memories (SPMs), etc.) shared by the processors/cores.

The kernel software unit 404 may include processor modules (CPU_0 Idle stats, CPU_1 idle stats, 2D-GPU_0 driver, 2D-GPU_1 driver, 3D-GPU_0 driver, etc.) that correspond to at least one of the processors/cores in the hardware unit 402, each of which may communicate with one or more idle stats device modules 408. The kernel unit 404 may also include input event modules 410, a deferred timer driver module 414, and a CPU request stats module 412.

The user space software unit 406 may include a consolidated DCVS control module 416. The consolidated DCVS control module 416 may include a software process/task, which may execute on any of the processing cores (e.g., CPU 0, CPU 1, 2D-GPU 0, 2D-GPU 1, 3D-GPU 0, etc.). For example, the consolidated DCVS control module may be a process/task that monitors a port or a socket for an occurrence of an event (e.g., filling of a data buffer, expiration of a timer, state transition, etc.) that causes the module to collect information from all the cores to be consolidated, synchronize the collected information within a given time/data window, determine whether the workloads are correlated (e.g., cross correlate pulse trains), and perform a consolidated DCVS operation across the selected cores.

In an aspect, the consolidated DCVS operation may be performed such that the frequency/voltages of the cores whose workloads are not correlated are reduced. As part of these operations, the consolidated DCVS control module 416 may receive input from each of the idle stats device modules 408, input event modules 410, deferred timer driver module 414, and a CPU request stats module 412 of the kernel unit 404. The consolidated DCVS control module 416 may send output to a CPU/GPU frequency hot-plug module 418 of the kernel unit 404, which may send communication signals to the resources module 420 of the hardware unit 402.

In an aspect, the consolidated DCVS control module 416 may include a single threaded dynamic clock and voltage scaling (DCVS) application that simultaneously monitors each core and correlates the operations of the cores, which may include generating one or more pulse trains. In an aspect, instead of monitoring the cores to generate the pulse trains, virtual pulse trains may be generated from information obtained from operating system run queues. In any case, the generated pulse trains may be synchronized in time and cross-correlated to correlate processor workloads. The synchronization of the virtual pulse trains, and the correlation of the workloads, enables the system to determine whether the cores are performing operations that are co-operative and/or dependent on one another. This information may be used to determine an optimal voltage/frequency for each core, either for each of the cores individually or for all the cores collectively, and to adjust the frequency and/or voltage of the cores accordingly. For example, the frequency/voltage of the processing cores may be adjusted based on a calculated probability that the cores are performing operations that are cooperative and/or dependent on one another. These voltage/frequency changes may be applied to each core simultaneously, or at approximately the same point in time, via the CPU/GPU frequency hot-plug module 418.

The generation and synchronization of virtual pulse trains, and the correlation of the workloads across two or more selected cores, are important and distinguishing elements that are generally lacking in existing multiprocessor DCVS solutions.

As discussed above, identifying workload correlations may be difficult in multiprocessor systems that take idle or underutilized processors “offline” by, for example, power collapsing the processors. Offline processors are always “non-active,” and as a result, do not have busy-idle cycles from which the pulse trains can be generated. Moreover, while pulse trains generated from a busy idle cycle may be used to determine when an online processor should be taken offline, this information does not provide any insight on whether or not any of the offline processors should be brought online. For example, while the idleness of a processor may indicate that the system is operating at less than its operational capacity, a processor operating at 100% capacity does not necessarily indicate additional processing resources are necessary.

The various aspects overcome these and other limitations by monitoring the depth of processor run queues (as opposed to their busy-idle cycles) to generate virtual pulse trains, which may be used to more accurately identify correlations between processor workloads on systems that include offline processors.

A run-queue may include a running thread as well as a collection of one or more threads that are capable of running on a processor, but not yet able to do so (e.g., due to another active thread that is currently running, etc.). Each processing unit may have its own run-queue, or a single run-queue may be shared my multiple processing units. Threads may be removed from the run queue when they request to enter a sleep state, are waiting on a resource to become available, or have been terminated. Thus the number of threads in the run queue (i.e., the run queue depth) may identify the number of active processes (e.g., waiting, running), including the processes currently being processed (running) and the processes waiting to be processed.

Various aspects may use the run queue depth to determine how many processors are busy and/or required at any given point in time. If there are fewer entries in the run queue than there are available processors, the various aspects may determine that not all the processors are being used. Likewise, if the number of entries in the run queue is greater than the number of online processors, the various aspects may determine that additional processors are needed.

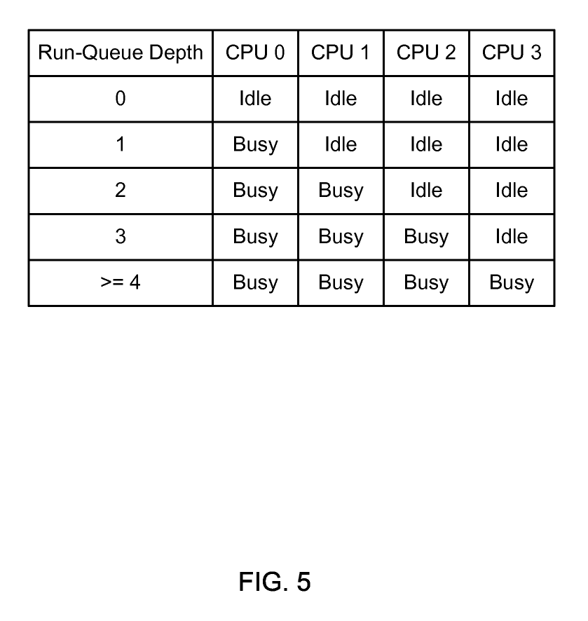

FIG. 5 illustrates an example correlation between the run queue depth and the number of processing cores that are, or should be, busy on a multicore processor that include four cores (CPUs 0-3). If the run queue is empty (i.e., run queue depth is 0), the system may determine that there are no threads actively waiting for processing resources, and that all offline processors would be idle if brought online. If the run queue contains a single thread (i.e., run queue depth is 1), the system may generate a virtual pulse train that identifies CPU0 as being busy or that it should be busy. If the run queue contains two entries (i.e., run queue depth is 2), the system may generate a virtual pulse train that identifies CPU0 and CPU1 as being busy, or that they would be busy if they were online. Likewise, if the run queue contains three entries (i.e., run queue depth is 3), the system may generate a virtual pulse train that identifies CPU0, CPU1, and CPU2 as being busy, or that they would be busy if they were all online. If the run queue contains four or more entries (i.e., run queue depth is greater than or equal to 4), the system may generate a pulse train that identifies all the CPUs as being busy, or that they should be busy.

On operating systems that maintain a run queue for each processor, the total depth across all the run queues may be used to identify the number of threads that are waiting for processing at any given instant. For example, various aspects may aggregate the depth of all processor run queues, accounting for both the online and offline processors. The aggregated depth may be used to generate/equip virtual pulse trains. If a virtual pulse train associated with an offline processor is identified as being busy (or on average busy), the system may perform operations to bring the offline processor online by, for example, energizing the offline processor.

In an aspect, if the virtual pulse trains identify that the number of entries in the run queue is greater than the number of active CPUs, additional CPUs may be brought online. Transient deadlines may be placed on the offline processors such that they are brought online only if they are identified based on the virtual pulse trains as being busy for a predetermined amount of time. In an aspect, if the number of entries in the run queue is less than the number of active CPUs, the frequency of one or more of the active CPUs may be reduced.

In an aspect, the power consumption characteristics of the processors may be used to determine whether an offline processor should be brought online. In an aspect, the power differential between running a first number of processor and running a second number of processors may calculated. The calculated power differential may be used to determine whether or not more processors should be brought online, or taken offline. For example, the calculated power differential may be used to determine if it is more efficient to run the first number of processors or the second number of processors, and respond accordingly.

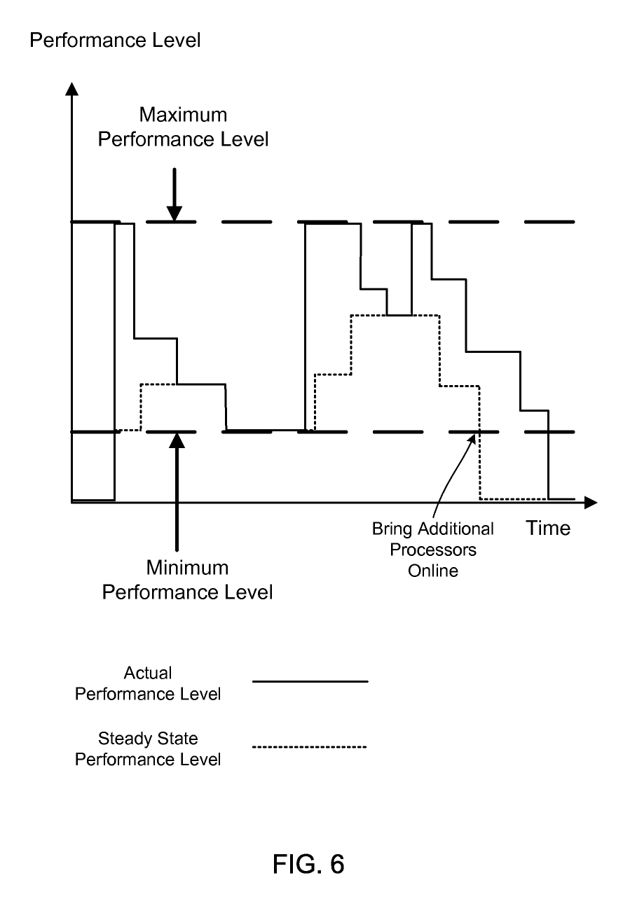

FIG. 6 illustrates actual and steady state performance levels of a multiprocessor system that correlates processor workloads using virtual pulse trains in accordance with an aspect. Specifically, FIG. 6 illustrates that the multiprocessor system may monitor the overall device performance to insure that the multiprocessor system operates between established maximum and minimum levels, and adjust the processing resources to be commensurate with the established levels. For example, the system may determine whether the actual and/or steady state performance levels meet or exceed the established maximum and minimum performance levels. If it is determined that the steady state exceeds the maximum performance level, the frequency/voltage of one or more of the online processors may be reduced. If it is determined that the steady state is below the minimum performance level, the frequency/voltage of one or more of the online processors may be increase, or one or more offline processors may be brought online.

Various aspects predict how busy an offline processor would be if the processor were to be brought online based on the generated virtual pulse chains. Various aspects use the predicted processor workloads to determine if one or more offline processors should be energized or otherwise brought online, if the system is using an optimal number of processors, or if additional processors should be power collapsed or taken offline. Various aspects may use the predicted processor workloads to determine an optimal frequency and/or voltage for the processors. In an aspect, if it is determined that more processors should be brought online, predicted workloads based on the virtual pulse chains may be used to determine an optimal operating frequency at which an offline processor should be brought online.

Various aspects correlate the workloads (e.g., busy versus idle states) of two or more processing cores, and scale the frequency/voltage of the cores to a level consistent with the correlated processes such that the processing performance is maintained and maximum energy efficiency is achieved. Various aspects determine which processors should be controlled by the consolidated DCVS scheme, and which processors should have their frequencies/voltages scaled independently. For example, the various aspects may use virtual pulse chains to consolidate the DCVS schemes of two CPUs and a two-dimensional graphics processor, while operating an independent DCVS scheme on a three-dimensional graphics processor.

These correlated workloads may be more reflective of the multiprocessor's true workloads and capabilities, enabling threads to be more accurately scheduled across the multiple cores. These correlated workloads also enable the multiprocessor system to make better decisions regarding how many processors are required to perform active tasks, and at what frequency/voltage the online processors should operate. These correlated workloads also allow the multiprocessor system to apply accurate dynamic clock frequency/voltage scaling (DCVS) schemes that take into account the availability and capabilities of all processing resources, including online and offline processors.

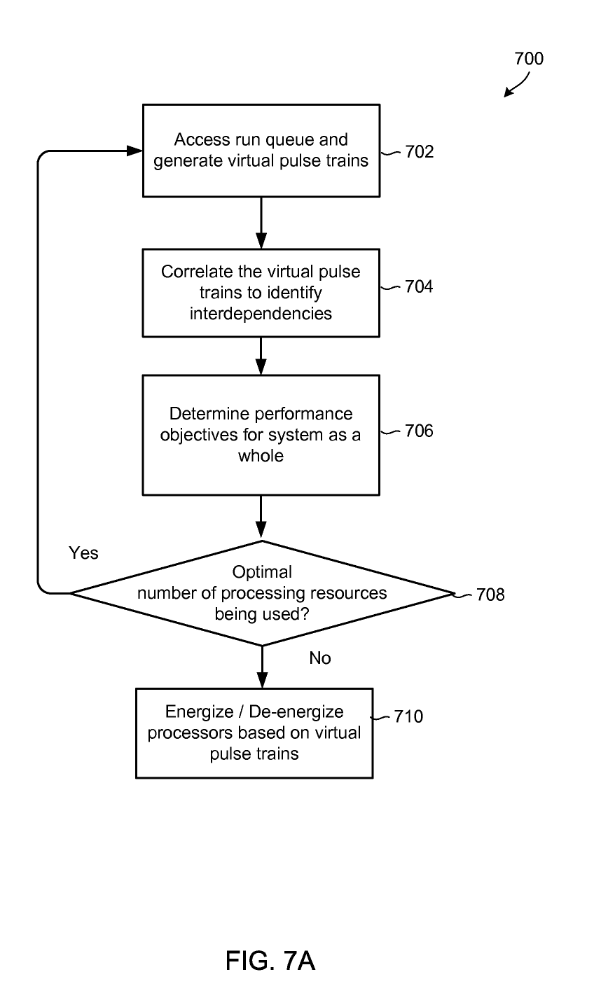

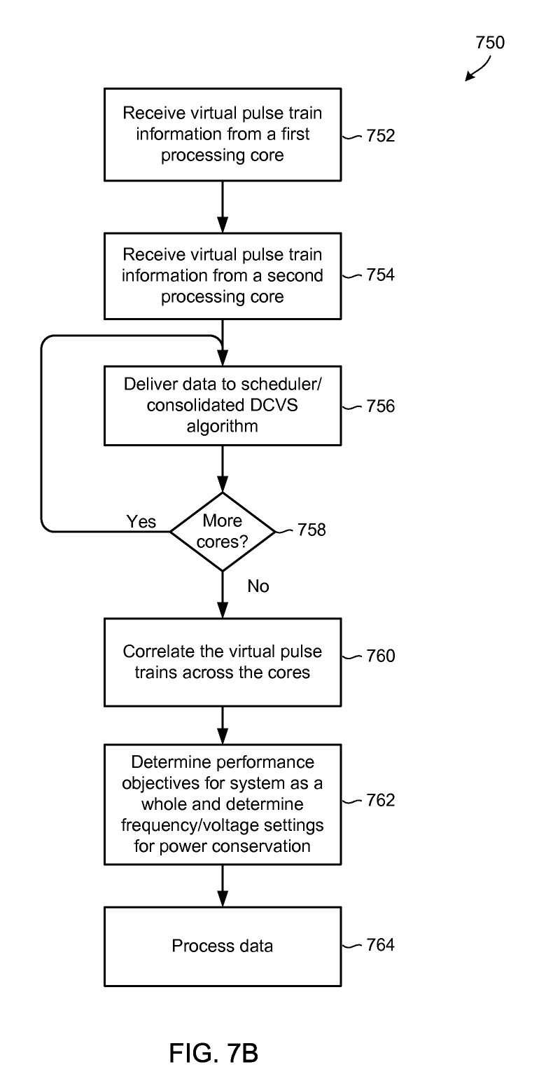

FIG. 7A illustrates an aspect method 700 for utilizing information obtained from virtual pulse trains to determine if an optimal number of processing resources in accordance with an aspect. In block 702, the total depth across all the run queues may be used to identify the number of threads in waiting for processing and to generate a virtual pulse train for each processor. The virtual pulse train generation may include scaling the original busy pulses inferred from the run queue depth by a factor that depends on the number CPUs currently online and the total number of available CPUs in the system. These scaling operations may be applied to the original busy pulses such that the resulting pulse train can predict how busy an offline processor would be if the processor were to be brought online. In block 704, the generated virtual pulse trains may be correlated to identify interdependencies between two or more of the cores. In block 706, the multiprocessor system may determine the performance requirements for the system as a whole, accounting for correlations and interdependencies between the cores or processes based on the generated virtual pulse chains. In determination block 708, the multiprocessor system may determine if an optimal number of processing resources are currently being used to meet the identified performance objectives. If an optimal number of processing resources are currently in use (determination block 708=“Yes”), in block 702, the run queue may be accessed to generate updated virtual pulse trains and the process repeated. If an optimal number of processing resources are not currently in use (determination block 708=“No”), in block 710, the multiprocessor systems may energize offline processors or power-collapse online processors to achieve the optimal number of processing resources based on the virtual pulse chains. In an aspect, if it is determined that more processors should be brought online, predicted workloads may be used to determine an optimal operating frequency at which an offline processor should be brought online. This process may be repeated on a continuous basis so the generated virtual pulse chains continually reflect the current run queue and core workloads.

FIG. 7B illustrates an aspect method 750 for utilizing information obtained from virtual pulse trains to dynamically correlate processor workloads across some or all processing cores within a multiprocessor system. The aspect method 750 may be implemented, for example, as a consolidated dynamic clock and voltage scaling (DCVS) task/process operating in the user space of a computing device having a multicore processor. The aspect method 750 may also be implemented as part of a scheduling mechanism (e.g., operating system scheduler) that schedules threads to run on cores.

In block 752 of method 750, run queue depth information may be received from a first processing core in a virtual pulse train format, with the virtual pulse trains being analyzed in a consolidated DCVS module/process (or an operating system component). In block 754, time synchronized virtual pulse trains (or information sets) may be received from a second processing core by the consolidated DCVS module (or an operating system component). The virtual pulse trains received from the second processing core may be synchronized in time by tagging or linking them to a common system clock, and collecting the data within defined time windows synchronized across all monitored processing cores. In block 756, the virtual pulse trains from both the first and second cores may be delivered to a consolidated DCVS module for analysis. In determination block 758 the consolidated DCVS module may determine if there are more processing cores from which to gather additional virtual pulse train information. If so (i.e., determination block 758=“YES”), the processor may continue to receive virtual pulse train information from the other processors/cores to the consolidated DCVS module in block 756. Once all virtual pulse train information has been obtained from all selected processing cores, (i.e., determination block 508=“NO”), the processor may correlate the virtual pulse trains across the processors/cores in block 760.

The analysis of the virtual pulse trains for each of the processing cores may be time synchronized to allow for the correlation of the predicted idle, busy, and wait states information among the cores during the same data windows. Within identified time/data windows, the processor may determine whether the cores are performing operations in a correlated manner (e.g., there exists a correlation between the busy and idle states of the two processors). In an aspect, the processor may also determine if threads executing on two or more of the processing cores are cooperating/dependent on one another by “looking backward” for a consistent interval (e.g., 10 milliseconds, 1 second, etc.). For example, the virtual pulse trains relating to the previous ten milliseconds may be evaluated for each processing core to identify a pattern of cooperation/dependence between the cores.

In time synchronizing the virtual pulse trains to correlate the states (e.g., idle, busy, wait, I/O) of the cores within a time/data window, the window may be sized (i.e., made longer or shorter) dynamically. In an aspect, the window size may not be known or determined ahead of time, and may be sized on the fly. In an aspect, the window size may be consistent across all cores.

In block 762, the consolidated DCVS module may use the correlated information sets to determine the performance requirements for the system as a whole based on any correlated or interdependent cores or processes, and may increase or decrease the frequency/voltage applied to all processing cores in order to meet the system's performance requirements while conserving power. In block 764, the frequency/voltage settings determined by the consolidated DCVS module may be implemented in all the selected processing cores simultaneously.

In an aspect, as part of blocks 760 and/or 762, the consolidated DCVS module may determine whether there are any interdependent operations currently underway among two or more of the multiple processing cores. This may be accomplished, for example, by determining whether any processing core virtual pulse trains are occurring in an alternating pattern, indicating some interdependency of operations or threads. Such interdependency may be direct, such that operations in one core are required by the other and vice versa, or indirect, such that operations in one core lead to operations in the other core.

It should be appreciated that various core configurations are possible and within the scope of the present disclosure, and that the processing cores need not be general purpose processors. For example, the cores may include a central processing unit (CPU), digital signal processor (DSP), graphics processing unit (GPU) and/or other hardware cores that do not execute instructions, but which are clocked and whose performance is tied to a frequency at which the cores run. Thus, in an aspect, the voltage of a CPU may be scaled in coordination with the voltage of a GPU. Likewise, the system may determine that the voltage of a CPU should not be scaled in response to determining that the CPU and a GPU have correlated workloads.

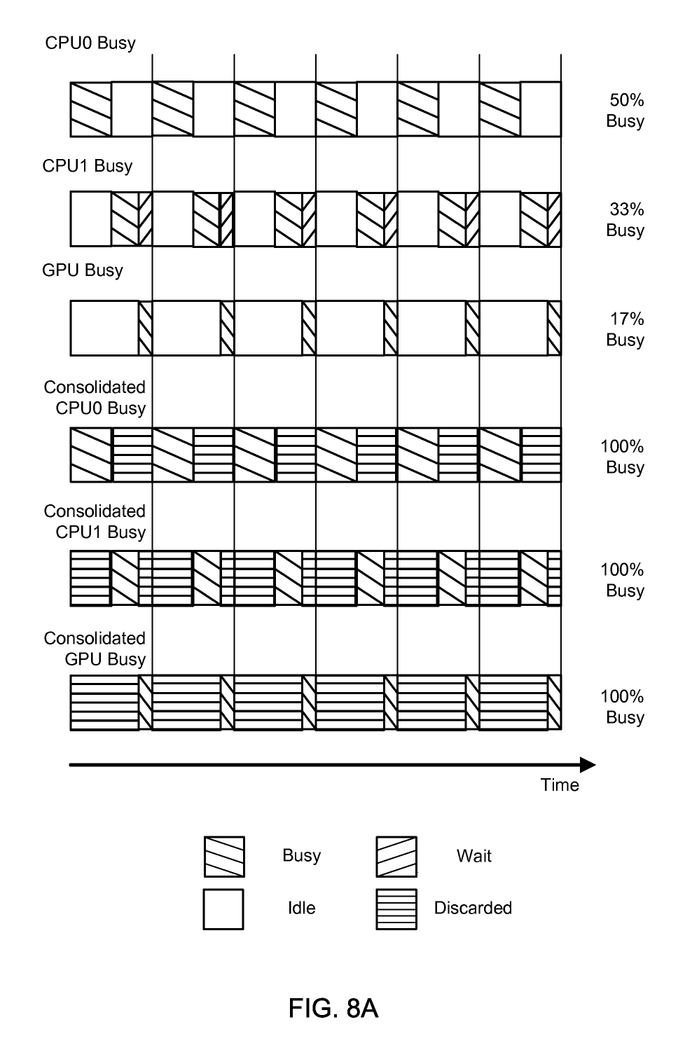

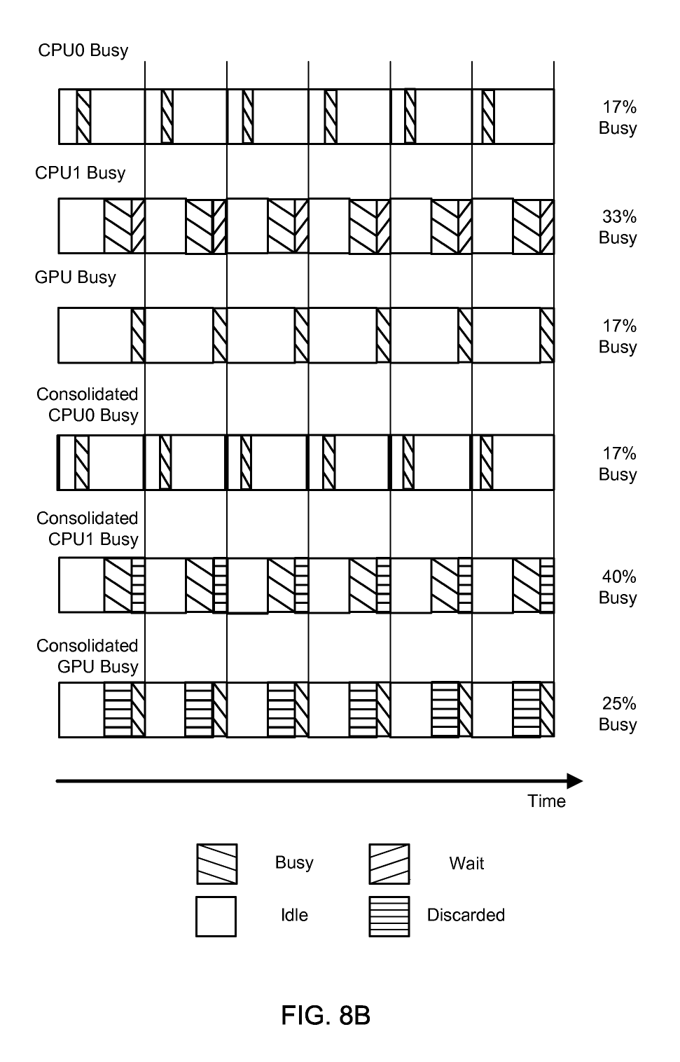

As mentioned above, the various aspects recognize interdependence of processes executing on the various cores of a multiprocessor device, including online and offline processors, by generating pulse trains. FIGS. 8A and 8B illustrate these interdependences. For example, FIG. 8A illustrates that the alternating busy/idle states of CPU_0, CPU_1 and GPU processing cores suggest that whatever processes are going on in these cores are interdependent since overlaps or gaps between the alternating pulses are minimal when the pulse trains are viewed from a consolidated perspective. When such interdependent states are recognized, the consolidated DCVS algorithm generates consolidated DCVS pulse trains (Consolidated CPU0 Busy, Consolidated CPU1 Busy, Consolidated GPU Busy) for the interacting processing cores that reflect the interdependencies of the ongoing processes. By evaluating the opportunity for scaling down frequency/voltage based upon the consolidated pulse trains, the consolidated DCVS algorithm can scale the frequency/voltage for either or both of the interacting processing cores for the consolidated periods in a manner that is consistent with the work being accomplished by the cores.

FIG. 8B illustrates an example situation in which the CPU_0 and CPU_1 processing cores are operating independently (i.e., interdependency is not indicated). This is revealed by a pattern of pulse trains which feature overlapping idle periods, which occur when there is an overlap in the end of one busy period on a first processing core (CPU 0) with the start of the next busy period on another processing core (CPU 1). Overlapping idle periods (or busy periods) may be one indication that the processes and operations occurring in each processing core are not interdependent or correlated to each other.

The absence of interdependence may be revealed in consolidated pulse trains (Consolidated CPU0 Busy, Consolidated CPU1 Busy, Consolidated GPU Busy) by the existence of consolidated idle periods, unlike the consolidated pulse trains of interdependent processes illustrated in FIG. 8A which have no or only brief idle periods. This illustrates how the frequency/voltage settings for each of the processing cores may be determined independently based upon the idle periods or busy-to-idle ratio computed from the virtual pulse trains. The figures also illustrate how generating consolidated virtual pulse trains may be used to adjust the frequency/voltage settings for individual processing cores dynamically to accommodate occasionally interdependent operations. In other words, the consolidated pulse trains may be used to adjust the frequency/voltage settings of individual processing cores in a manner that takes into account operations in one or more of the other processing cores. For example, using the consolidated virtual pulse trains (Consolidated CPU0 Busy, Consolidated CPU1 Busy, Consolidated GPU Busy) the frequency/voltage setting for the CPU 0 processing core may be set higher than that of the GPU processing core due to the difference in predicted idle durations.

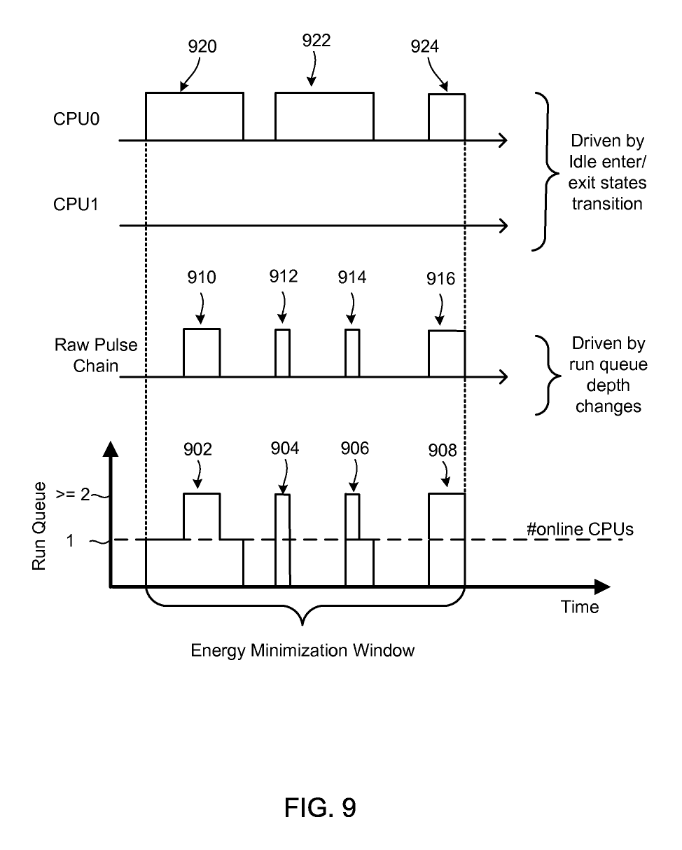

FIG. 9 illustrates pulse chains that may be generated based on changes in the run queue depth for the offline cores (i.e., generation of virtual pulse chains) and changes in idle enter/exit state for online cores (actual pulse chains). In the example illustrated in FIG. 9, the multiprocessor system includes a first and second processor (CPU0, CPU1), and the first processor (CPU0) is online and the second processor (CPU1) is offline. Actual pulses 920, 922, 924 may be generated for the first processor (CPU0) by measuring transitions between idle enter and idle exit states (or other states) of the online processor. However, since the second processor (CPU1) is offline, it does not produce any idle enter/exit pulses that may be measured to generate actual pulse chains.

In order to model the second processor's (CPU1) workload, the system may generate a raw pulse chain (e.g., virtual pulses 910, 912, 914, 916) that represents the workload of the offline processor if the offline processor were online and processing tasks. The virtual pulses 910, 912, 914, 916 may be generated based on the depth of the run queue. For example, in the illustrated two-processor system, when the number of threads in the run queue is greater than or equal to two 902, 904, 906, 908, an offline virtual processor (e.g., OFF_VCPU1) may generate virtual pulses 910, 912, 914, 916 that represent the workload of the second processor (CPU1) if it were online.

In an aspect, the DCVS mechanism may compute an energy minimization window (EM window). The system may determine if core(s) may be taken offline or brought online based on the number of actual and/or virtual pulse chains present within the EM window. For example, at the conclusion of the EM window, the number of actual and virtual pulse chains present within the EM window may be used to determine if the second processor (CPU1) should be brought online.

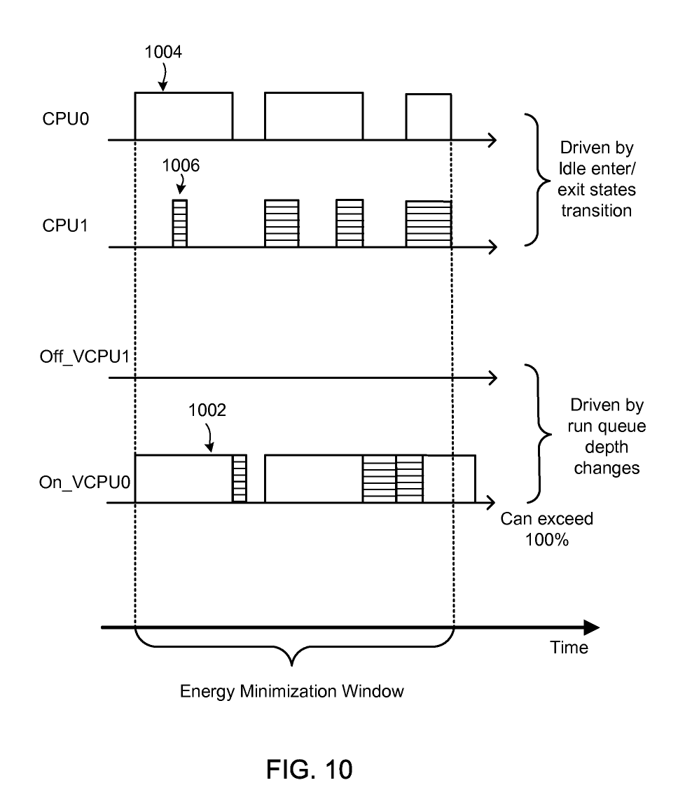

FIG. 10 illustrates that virtual pulse chains may be generated for online processors to represent the total amount of work that would be required of a first set of processor cores if a second set of processor cores were to be taken offline. In the example illustrated in FIG. 10, the multiprocessors system includes two processing cores (CPU0, CPU1), both of which are online and processing tasks. Actual pulse chains may be generated for each of the first and second processor cores (CPU0, CPU1) from measuring transitions between idle enter and idle exit states (or other states) of each of the online processor cores (CPU0, CPU1). Since the second processor is online, there are no pulses generated for the offline virtual processor (OFF_VCPU1).

In the example illustrated in FIG. 10, the offline virtual processor (OFF_VCPU1) is driven by the run queue depth changes, and the online virtual processor (ON_VCPU0) is derived from the “sum” of the pulse chains of the first and second processor cores (CPU0, CPU1).

As discussed above, in a multiprocessor system, any core may be taken offline (off lined) at any time. Before taking a processor off line (“off lining”), the system may determine the amount of work that would be required of a first processor core (e.g., CPU0) if a second processor core (e.g., CPU1) were to be taken offline. This information may be used to determine whether or not off lining the processor would, for example, overload or slow down the multiprocessor system.

In various aspects, an online virtual processor (ON_VCPU0) may generate virtual pulses that represent the workload of the first processor core (CPU0) if it were operating in single core mode (i.e., if the second processor core CPU were to be taken offline). For example, the online virtual processor (ON_VCPU0) may generate virtual pulses 1002 that are a combination of an actual pulse generated by the first processor core (CPU0) 1004 and an actual pulse generated by the second processor core (CPU1). These virtual pulses (e.g., 1002) may be representative of the total amount of work present on the first and second processors (CPU0, CPU1), and thus, of the total amount of work that would be required of the first processor core (CPU0) if the second processor core (CPU1) were offline.

The total amount of work identified by the virtual pulses may exceed 100 percent utilization of the computed energy minimization window (EM window). In an aspect, the second processing core (CPU1) may be taken offline if the utilization measured on the online virtual processor (ON_VCPU0) is less than or equal to 100 percent. In an aspect, the second processing core (CPU1) may be taken offline if the utilization measured on the online virtual processor (ON_VCPU0) is less than or equal to 20 percent. In an aspect, the second processing core (CPU1) may be taken offline if the utilization measured on the online virtual processor (ON_VCPU0) is less than or equal to a computed minimum value (e.g., MP_MIN_UTIL_PCT_SC).

In an aspect, a determination regarding whether the second processing core (CPU1) may be taken offline may be made using the following formula:

[EM(ON_{—}VCPU0)+Energy(HotPlug_off)]<[EM(CPU0)+EM(CPU1)] && ON_{—}VCPU0 utilization<=MP_MAX_UTIL_PCT_SC

where EM(c): is the best energy as computed by the Energy Minimization algorithm for the pulses of core c, and Energy(HotPlug_off) is the amount of energy consumed during a hot plugging transition to bring the second processing core (CPU1) offline.

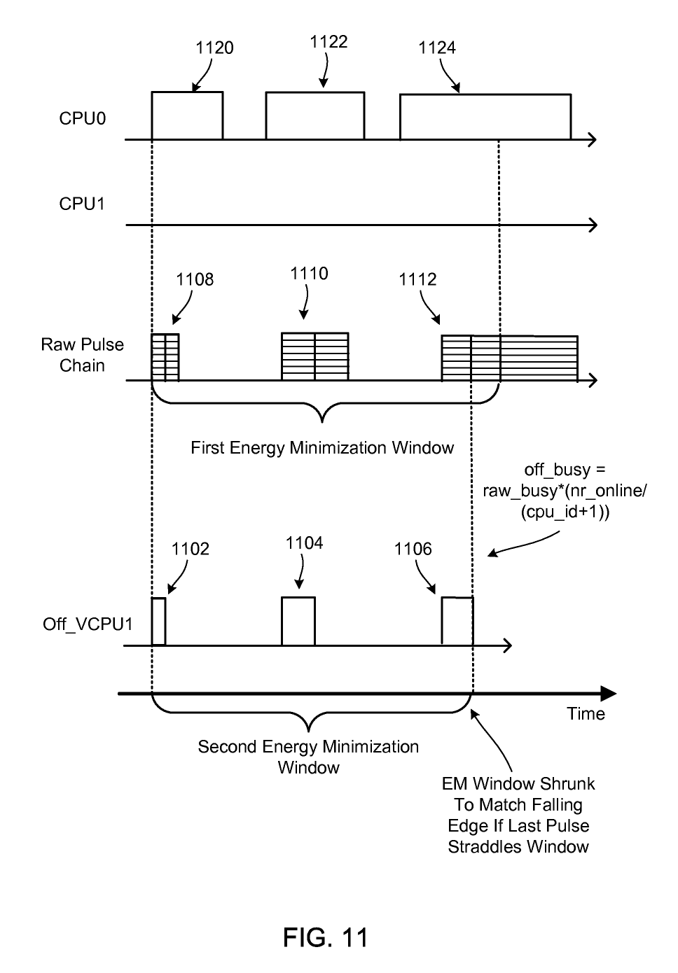

FIG. 11 illustrates that raw pulse chains may be inferred from the depth of the run queue and used to generate virtual pulses that represent the amount of work that an offline processor would do if that processor were online. In the example illustrated in FIG. 11, the multiprocessor system includes two processing cores (CPU0, CPU1), and the first processing core (CPU0) is online and processing tasks, while the second processing core (CPU1) is offline (i.e., the system is operating in single core mode). Actual pulses 1120, 1122, 1124 may be generated for the first processor core (CPU0) from measuring transitions between idle enter and idle exit states (or other states). Since the second processor (CPU1) is offline, there are no actual pulses generated for the second processor core.

In order to model the second processor's (CPU1) workload, an offline virtual processor (OFF_VCPU1) may generate a virtual pulse chain that is representative of the workload of the offline processor if the offline processor were online and processing tasks. A raw pulse chain may be generated based on the depth of the run queue. The offline virtual processor (OFF_VCPU1) may generate virtual pulses 1102, 1104, 1106 in a manner that may represent the amount of work that the second processor (CPU1) would do if it were online and all the work could be fully parallelized.

In an aspect, generating such virtual pulses 1102, 1104, 1106 may be accomplished by dividing the length of the raw virtual pulses 1108, 1110, 1112, which may be accomplished using the formula:

$$off\_busy = raw\_busy \cdot ( \frac{nr\_online}{( cpu\_id + 1 )} )$$

where:

off_busy is the resulting scaled pulse duration for OFF_VCPU;

raw_busy is the (unmodified) busy pulse inferred from run queue depth for an offline CPU; and

nr_online is the current number of online CPUs.

As mentioned above, the offline virtual processor (OFF_VCPU1) may generate the virtual pulses 1102, 1104, 1106 such that they represent half the workload identified by the raw virtual pulses 1108, 1110, 1112. In an aspect, the DCVS mechanism may compute a first energy minimization window (EM window) based on the raw pulse chains, the online processor core's (CPU) workload, or any combination thereof, and only the raw pulses 1108, 1110, 1112 that are within the first EM window are computed using the formula off_busy=raw_busy*(nr_online/(cpu_id+1)) discussed above.

In an aspect, a second energy minimization window may be computed. The size of the second energy minimization window may be adjusted based on the virtual pulse chains generated by offline virtual processor (OFF_VCPU1). For example, the second energy minimization window may be reduced in length to match a falling edge of the last pulse straddling the end of the first energy minimization window. In an aspect, at the conclusion of the second EM window, the number/length of actual and virtual pulse chains inside the second EM window may be used to determine whether the second processor (CPU1) should be brought online.

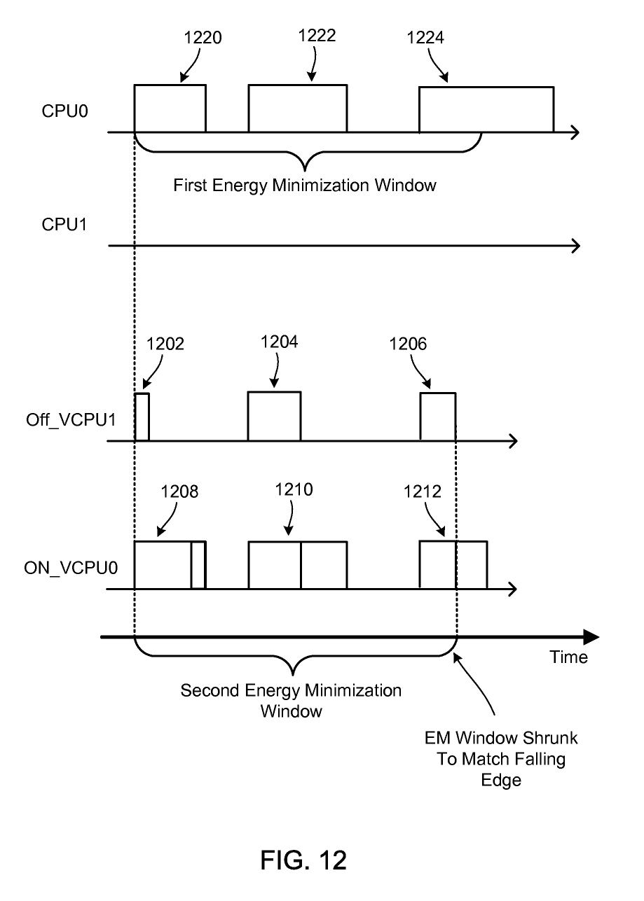

FIG. 12 illustrates that virtual pulse chains may be generated for both online and offline processors. In the example illustrated in FIG. 12, the multiprocessor system includes two processing cores (CPU0, CPU1) with the first processing core (CPU0) being online. In this example actual pulses 1120, 1122, 1224 may be generated for the first processor core (CPU0) from measuring transitions between idle enter and idle exit states (or other states). The second processor (CPU1) is offline and there are no actual pulses generated for the second processor core.

An offline virtual processor (OFF_VCPU1) may generate the virtual pulses 1202, 1204, 1206 in a manner that may represent the work that the second processor (CPU1) would do if the system was running in dual core mode (both cores were online) and all the work could be fully parallelized, such as by using the formula discussed above with reference to FIG. 11. An online virtual processor (ON_VCPU0) may generate virtual pulses 1208, 1210, 1212 that represent the work the first processor (CPU0) would do if the second processor core (CPU1) were online. This generation of virtual pulses 1208, 1210, 1212 may be achieved by combining the actual pulses 1220, 1222, 1224 with the virtual pulses 1202, 1204, 1206 by the offline virtual processor (OFF_VCPU1).

In an aspect, a DCVS mechanism may compute a first energy minimization window (EM window) based on the workload on the online processor core (CPU0). In an aspect, a second energy minimization window may be computed based on the virtual pulse chains generated by the offline virtual processor (OFF_VCPU1). For example, the second energy minimization window may be reduced in length to match a falling edge of the last pulse straddling the end of the first energy minimization window. In an aspect, at the conclusion of the second EM window, the number/length of actual and virtual pulse chains inside the second EM window may be used to determine whether the second processor (CPU1) should be brought online.

As discussed above, virtual pulse train generation may include scaling the original busy pulses inferred from the run queue depth by a factor that depends on the number CPUs currently online and the total number of available CPUs in the system. These scaling operations may be applied to the original busy pulses such that the resulting pulse train can predict how busy an offline processor would be if the processor were to be brought online. For example, the dual core examples discussed with reference to FIGS. 9-12 may be generalized and applied to systems having any number of processors/cores (e.g., for an N-core system). For example, in a multi-core system with an arbitrary number of available CPUs the following pulse scaling may be used:

$$off\_busy = raw\_busy \cdot ( \frac{nr\_online}{( cpu\_id + 1 )} )$$

where:

off_busy is the resulting scaled pulse duration for OFF_VCPU

raw_busy is the (unmodified) busy pulse inferred from run queue depth for an offline CPU, and

nr_online is the current number of online CPUs.

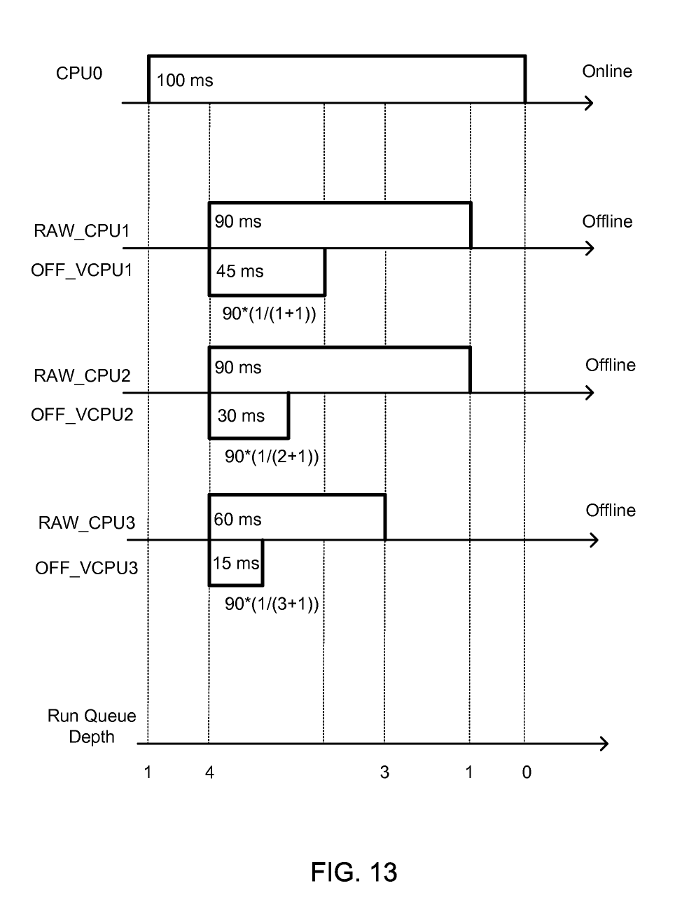

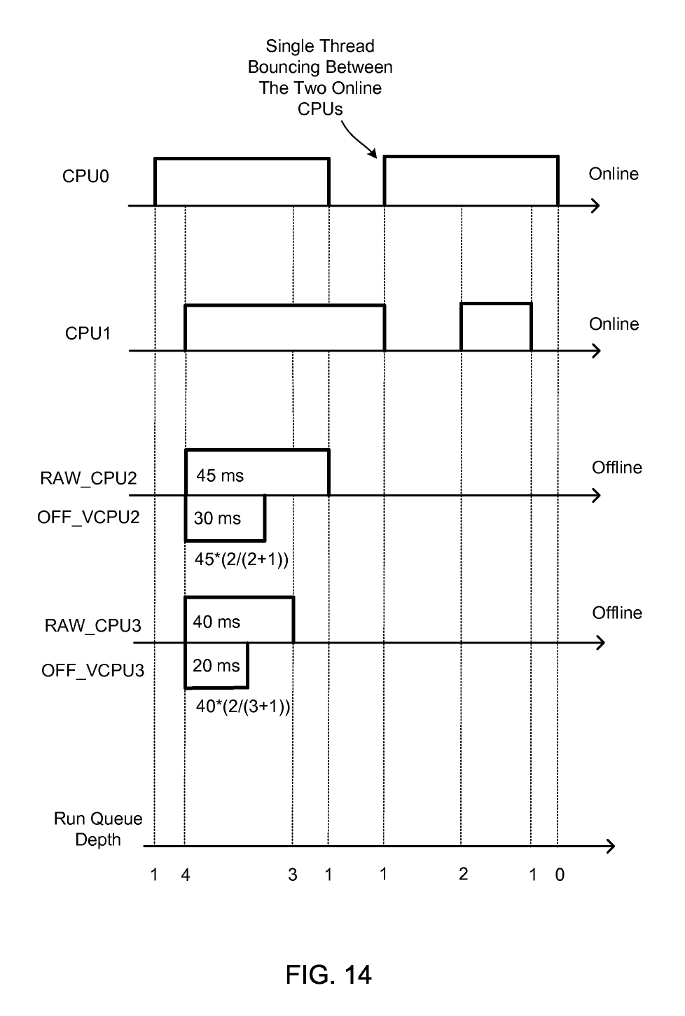

FIGS. 13-14 illustrate relationships between the number of processes in the run queue and processors in an N-core system, which may be used to apply the pulse scaling formulas discussed above. In the example illustrated in FIG. 13, the N-core system has four cores (n=4), with the first processing core (CPU0) online and remaining cores (CPU1, CPU2, CPU3) offline. Actual pulse chains may be generated for the first processor core (CPU0) from measuring transitions between idle enter and idle exit states (or other states). Offline virtual processors (OFF_VCPU1, OFF_VCPU2, OFF_VCPU3) may generate the virtual pulses to represent the work that their corresponding processor (CPU1, CPU2, CPU3) would do if that processor was online.

In the illustrated example, the unmodified busy pulse inferred from run queue depth is 90 milliseconds for CPU1, 90 milliseconds for CPU2, and 60 milliseconds for CPU3. Applying the pulse scaling formula discussed above, the resulting scaled pulse duration is 45 milliseconds for OFF_VCPU1 (90*(1/(1+1)), 30 milliseconds for OFF_VCPU2 (90*(1/(2+1)), and 15 milliseconds for OFF_VCPU3 (90*(1/(3+1)) in this example. These pulse durations may represent the work that their corresponding processor (CPU1, CPU2, CPU3) would do if it were online, and may be used to scale the voltage/frequency of the cores and/or used for determining if or when offline processors (e.g., CPU1, CPU2, CPU3) should be brought online.

In the example illustrated in FIG. 14, the N-core system has four cores (n=4), with the first and second processing cores (CPU0, CPU1) online and the remaining cores (CPU2, CPU3) offline. Actual pulse chains may be generated for the first and second processor cores (CPU0) from measuring transitions between idle enter and idle exit states (or other states) on their respective processors. Offline virtual processors (OFF_VCPU2, OFF_VCPU3) may generate the virtual pulses to represent the work that their corresponding processor (CPU2, CPU3) would do if that processor was online. In this example, the unmodified busy pulse inferred from run queue depth is 45 milliseconds for CPU2 and 40 milliseconds for CPU3. Applying the pulse scaling formula, the resulting scaled pulse duration is 30 milliseconds for OFF_VCPU2 (45*(2/(2+1)) and 40 milliseconds for OFF_VCPU3 (40*(2/(3+1)) in this example.

In an aspect, at the end of a computed EM window, the power of all the N configurations of online cores (1-core, 2-core, . . . , N-core active) may be computed using the follow formulas:

1-core: EM(vcpu0-0)

2-core: EM(vcpu0-1)+EM(vcpu1-1)

3-core: EM(vcpu0-2)+EM(vcpu1-2)+EM(vcpu2-2)

4-core: EM(vcpu0-3)+EM(vcpu1-3)+EM(vcpu2-3)+EM(vcpu3-3)

where: vcpu<cpu_id>-<config_id> are the virtual CPU pulses for a core with id <cpu_id> in configuration <config_id>, and where config_id “0” means single core, config_id “1” means dual core, and config_id N−1 means a configuration with N cores active.

The various aspects may be implemented within a system configured to steer threads to CPUs based on workload characteristics and a mapping to determine CPU affinity of a thread. A system configured with the ability to steer threads to CPUs in a multiple CPU cluster based upon each thread's workload characteristics may use workload characteristics to steer a thread to a particular CPU in a cluster. Such a system may steer threads to CPUs based on workload characteristics such as CPI (Clock cycles Per Instruction), number of clock cycles per busy period, the number of L1 cache misses, the number of L2 cache misses, and the number of instructions executed. Such a system may also cluster threads with similar workload characteristics onto the same set of CPUs.

The various aspects provide a number of benefits, and may be implemented in laptops and other mobile devices where energy is limited to improve battery life. The various aspects may also be implemented in quiet computing settings, and to decrease energy and cooling costs for lightly loaded machines. Reducing the heat output allows the system cooling fans to be throttled down or turned off, reducing noise levels, and further decreasing power consumption. The various aspects may also be used for reducing heat in insufficiently cooled systems when the temperature reaches a certain threshold.

While the various aspects are described above for illustrative purposes in terms of first and second processing cores, the aspect methods, systems, and executable instructions may be implemented in multiprocessor systems that include more than two cores. In general, the various aspects may be implemented in systems that include any number of processing cores in which the methods enable recognition of and controlling of frequency or voltage based upon correlations among any of the cores. The operations of scaling the frequency or voltage may be performed on each of the processing cores.

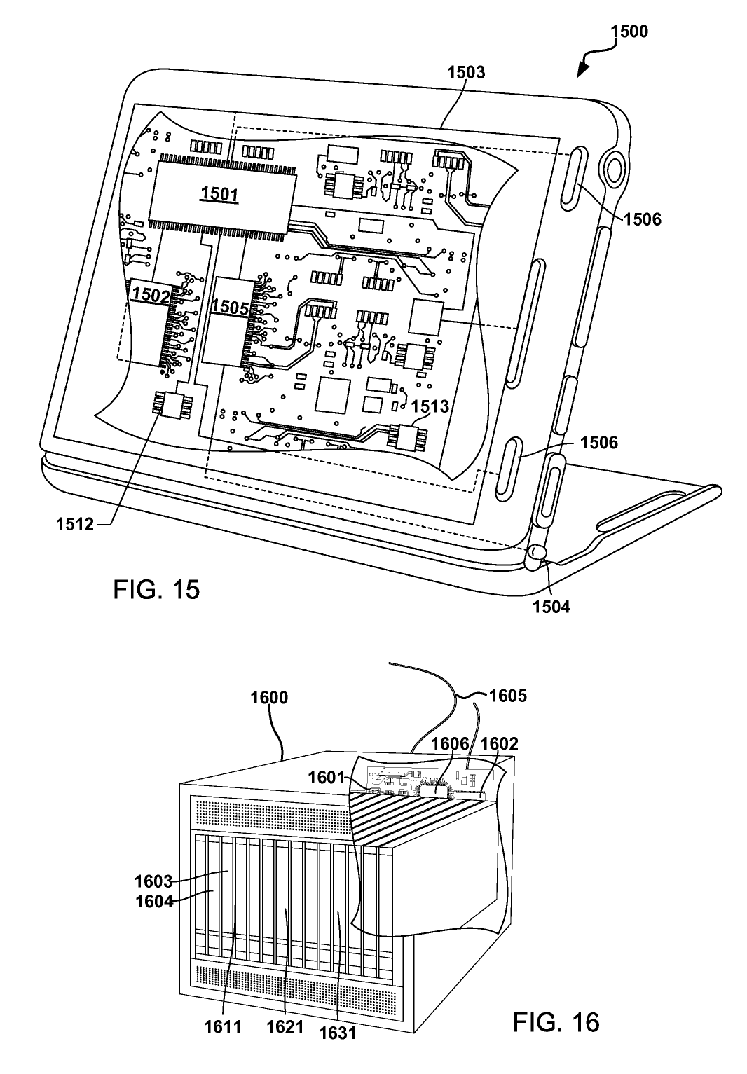

The various aspects may be implemented in a variety of mobile computing devices, an example of which is illustrated in FIG. 15. The mobile computing device 1500 may include a multi-core processor 1501 coupled to memory 1502 and to a radio frequency data modem 1505. The multi-core processor 1501 may include circuits and structure similar to those described above and illustrated in FIGS. 1-3. The modem 1505 may also include multiple processing cores, and may be coupled to an antenna 1504 for receiving and transmitting radio frequency signals. The computing device 1500 may also include a display 1503 (e.g., touch screen display), user inputs (e.g., buttons) 1506, and a tactile output surface, which may be positioned on the display 1503 (e.g., using E-Sense™ technology), on a back surface 1512, or another surface of the mobile device 1500.

The mobile device processor 1501 may be any programmable multi-core multiprocessor, microcomputer or multiple processor chips that can be configured by software instructions (applications) to perform a variety of functions, including the functions and operations of the various aspects described herein.

Typically, software applications may be stored in the internal memory 1502 before they are accessed and loaded into the processor 1501. In some mobile computing devices, additional memory chips (e.g., a Secure Data (SD) card) may be plugged into the mobile device and coupled to the processor 1501. The internal memory 1502 may be a volatile or nonvolatile memory, such as flash memory, or a mixture of both. For the purposes of this description, a general reference to memory refers to all memory accessible by the processor 1501, including internal memory 1502, removable memory plugged into the mobile device, and memory within the processor 1501.

The various aspects may also be implemented on any of a variety of commercially available server devices, such as the server 1600 illustrated in FIG. 16. Such a server 1600 typically includes a processor 1601, and may include multiple processor systems 1611, 1621, 1631, one or more of which may be or include multi-core processors. The processor 1601 may be coupled to volatile memory 1602 and a large capacity nonvolatile memory, such as a disk drive 1603. The server 1600 may also include a floppy disc drive, compact disc (CD) or DVD disc drive 1606 coupled to the processor 1601. The server 1600 may also include network access ports 1604 coupled to the processor 1601 for establishing data connections with a network 1605, such as a local area network coupled to other broadcast system computers and servers. The processors 1501, 1601 may be any programmable multiprocessor, microcomputer or multiple processor chip or chips that can be configured by software instructions (applications) to perform a variety of functions, including the functions of the various aspects described above. In some devices, multiple processors 1501, 1601 may be provided, such as one processor dedicated to wireless communication functions and one processor dedicated to running other applications. Typically, software applications may be stored in the internal memory 1502, 1602, and 1603 before they are accessed and loaded into the processor 1501, 1601.

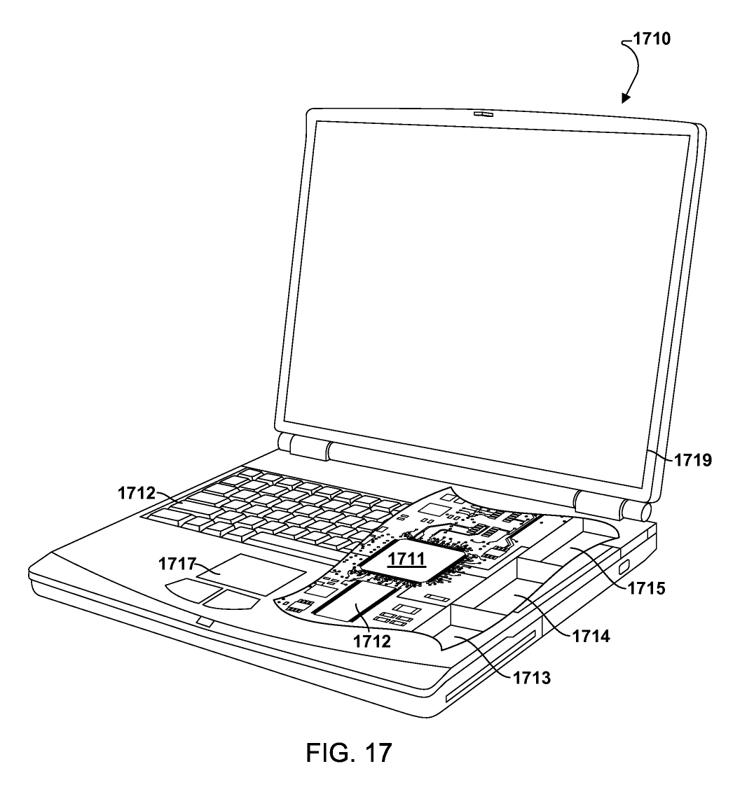

The aspects described above may also be implemented within a variety of personal computing devices, such as a laptop computer 1710 as illustrated in FIG. 17. A laptop computer 1710 may include a multi-core processor 1711 coupled to volatile memory 1712 and a large capacity nonvolatile memory, such as a disk drive 1713 of Flash memory. The computer 1710 may also include a floppy disc drive 1714 and a compact disc (CD) drive 1715 coupled to the processor 1711. The computer device 1710 may also include a number of connector ports coupled to the multi-core processor 1710 for establishing data connections or receiving external memory devices, such as a USB or FireWire® connector sockets, or other network connection circuits for coupling the multi-core processor 1711 to a network. In a notebook configuration, the computer housing includes the touchpad 1717, the keyboard 1718, and the display 1719 all coupled to the multi-core processor 1711. Other configurations of computing device may include a computer mouse or trackball coupled to the processor (e.g., via a USB input) as are well known.

The processor 1501, 1601, 1710 may include internal memory sufficient to store the application software instructions. In many devices the internal memory may be a volatile or nonvolatile memory, such as flash memory, or a mixture of both. For the purposes of this description, a general reference to memory refers to memory accessible by the processor 1501, 1601, 1710 including internal memory or removable memory plugged into the device and memory within the processor 1501, 1601, 1710 itself.

The foregoing method descriptions and the process flow diagrams are provided merely as illustrative examples and are not intended to require or imply that the steps of the various aspects must be performed in the order presented. As will be appreciated by one of skill in the art the order of steps in the foregoing aspects may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a multiprocessor, but, in the alternative, the processor may be any conventional processor, controller, microcontroller, or state machine. A processor may also be implemented as a combination of computing devices, e.g., a combination of a DSP and a multiprocessor, a plurality of multiprocessors, one or more multiprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more processor-executable instructions or code on a non-transitory computer-readable storage medium. The steps of a method or algorithm disclosed herein may be embodied in a processor-executable software module which may reside on a tangible or non-transitory computer-readable storage medium. Non-transitory computer-readable storage media may be any available storage media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also can be included within the scope of non-transitory computer-readable media. Additionally, the operations of a method or algorithm may reside as one or any combination or set of codes and/or instructions on a non-transitory machine readable medium and/or non-transitory computer-readable medium, which may be incorporated into a computer program product.

The preceding description of the disclosed aspects is provided to enable any person skilled in the art to make or use the present invention. Various modifications to these aspects will be readily apparent to those skilled in the art, and the generic principles defined herein may be applied to other aspects without departing from the spirit or scope of the invention. Thus, the present invention is not intended to be limited to the aspects shown herein but is to be accorded the widest scope consistent with the following claims and the principles and novel features disclosed herein.

What is claimed is:

1. A method of improving performance on a multiprocessor system having two or more processing cores, the method comprising:
accessing an operating system run queue to generate a first virtual pulse train for a first processing core and a second virtual pulse train for a second processing core; and
correlating the first and second virtual pulse trains to identify an interdependence relationship between the operations of the first processing core and the operations of the second processing core.

2. The method of claim 1, further comprising:
scheduling threads on the first and second processor cores based on the interdependence relationship between the operations of the first processing core and the operations of the second processing core.

3. The method of claim 1, further comprising:
performing dynamic clock and voltage scaling operations that include scaling a frequency or voltage of the first and second processor cores according to a correlated information set when an interdependence relationship is identified between the operations of the first processing core and the operations of the second processing core based on the correlation between the first and second virtual pulse trains.

4. The method of claim 1, further comprising:
performing dynamic clock and voltage scaling operations that include scaling a frequency or voltage of the first and second processor cores independently when no interdependence relationship is identified between the operations of the first processing core and the operations of the second processing core based on the correlation between the first and second virtual pulse trains.

5. The method of claim 1, further comprising:
generating predicted processor workloads that account for all available processing resources, including both online and offline processors, based on the correlation between the first and second virtual pulse trains.

6. The method of claim 5, wherein generating predicted processor workloads comprises predicting an operating load under which an offline processor would be if the offline processor were online.

7. The method of claim 5, further comprising:
determining whether an optimal number of processing resources are currently in use by the multiprocessor system; and
determining if one or more online processors should be taken offline in response to determining that the optimal number of processing resources are not currently in use.

8. The method of claim 7, further comprising:
reducing a frequency of the first or second processor to zero in response to determining that one or more online processors should be taken offline.

9. The method of claim 5, further comprising:
determining if an optimal number of processing resources are currently in use by the multiprocessor system; and
determining if one or more offline processors should be brought online in response to determining that the optimal number of processing resources are not currently in use.

10. The method of claim 9, further comprising:
determining an optimal operating frequency at which an offline processor should be brought online based on the predicted workloads in response to determining one or more offline processors should be brought online.

11. The method of claim 1, further comprising synchronizing the first and second virtual pulse trains in time.

12. The method of claim 11, further comprising correlating the synchronized first and second virtual pulse trains by overlaying the first virtual pulse train on the second virtual pulse train.

13. The method of claim 12, wherein a single thread executing on the multiprocessor system performs dynamic clock and voltage scaling operations.

14. The method of claim 12, wherein correlating the synchronized first and second information sets comprises producing a consolidated pulse train for each of the first and the second processing cores.

15. A computing device, comprising:
a memory; and
two or more processor cores coupled to the memory, wherein at least one of the processor cores is configured with processor-executable instructions to cause the computing device to perform operations comprising:
accessing an operating system run queue to generate a first virtual pulse train for a first processing core and a second virtual pulse train for a second processing core; and
correlating the first and second virtual pulse trains to identify an interdependence relationship between the operations of the first processing core and the operations of the second processing core.

16. The computing device of claim 15, wherein at least one of the processor cores is configured with processor-executable instructions to cause the computing device to perform operations further comprising:
scheduling threads on the first and second processor cores based on the interdependence relationship between the operations of the first processing core and the operations of the second processing core.

17. The computing device of claim 15, wherein at least one of the processor cores is configured with processor-executable instructions to cause the computing device to perform operations further comprising:
performing dynamic clock and voltage scaling operations that include scaling a frequency or voltage of the first and second processor cores according to a correlated information set when an interdependence relationship is identified between the operations of the first processing core and the operations of the second processing core based on the correlation between the first and second virtual pulse trains.

18. The computing device of claim 15, wherein at least one of the processor cores is configured with processor-executable instructions to cause the computing device to perform operations further comprising:
performing dynamic clock and voltage scaling operations that include scaling a frequency or voltage of the first and second processor cores independently when no interdependence relationship is identified between the operations of the first processing core and the operations of the second processing core based on the correlation between the first and second virtual pulse trains.

19. The computing device of claim 15, wherein at least one of the processor cores is configured with processor-executable instructions to cause the computing device to perform operations further comprising
generating predicted processor workloads that account for all available processing resources, including both online and offline processors, based on the correlation between the first and second virtual pulse trains.

20. The computing device of claim 19, wherein at least one of the processor cores is configured with processor-executable instructions such that generating predicted processor workloads comprises predicting an operating load under which an offline processor would be if the offline processor were online.

21. The computing device of claim 19, wherein at least one of the processor cores is configured with processor-executable instructions to cause the computing device to perform operations further comprising:
determining whether an optimal number of processing resources are currently in use by the computing device; and
determining if one or more online processors should be taken offline in response to determining that the optimal number of processing resources are not currently in use.

22. The computing device of claim 21, wherein at least one of the processor cores is configured with processor-executable instructions to cause the computing device to perform operations further comprising:
reducing a frequency of the first or second processor to zero in response to determining that one or more online processors should be taken offline.

23. The computing device of claim 19, wherein at least one of the processor cores is configured with processor-executable instructions to cause the computing device to perform operations further comprising:
determining if an optimal number of processing resources are currently in use by the computing device; and
determining if one or more offline processors should be brought online in response to determining that the optimal number of processing resources are not currently in use.

24. The computing device of claim 23, wherein at least one of the processor cores is configured with processor-executable instructions to cause the computing device to perform operations further comprising:
determining an optimal operating frequency at which an offline processor should be brought online based on the predicted workloads in response to determining one or more offline processors should be brought online.

25. The computing device of claim 15, wherein at least one of the processor cores is configured with processor-executable instructions to cause the computing device to perform operations further comprising:
synchronizing the first and second virtual pulse trains in time.

26. The computing device of claim 25, wherein at least one of the processor cores is configured with processor-executable instructions to cause the computing device to perform operations further comprising:
correlating the synchronized first and second virtual pulse trains by overlaying the first virtual pulse train on the second virtual pulse train.

27. The computing device of claim 26, wherein at least one of the processor cores is configured with processor-executable instructions such that a single thread executing on one of the processor cores performs dynamic clock and voltage scaling operations.

28. The computing device of claim 26, wherein at least one of the processor cores is configured with processor-executable instructions such that correlating the synchronized first and second information sets comprises producing a consolidated pulse train for each of the first and the second processing cores.

29. A computing device, comprising:
means for accessing an operating system run queue to generate a first virtual pulse train for a first processing core and a second virtual pulse train for a second processing core; and
means for correlating the first and second virtual pulse trains to identify an interdependence relationship between the operations of the first processing core and the operations of the second processing core.

30. The computing device of claim 29, further comprising:
means for scheduling threads on the first and second processor cores based on the interdependence relationship between the operations of the first processing core and the operations of the second processing core.

31. The computing device of claim 29, further comprising:
means for performing dynamic clock and voltage scaling operations that include scaling a frequency or voltage of the first and second processor cores according to a correlated information set when an interdependence relationship is identified between the operations of the first processing core and the operations of the second processing core based on the correlation between the first and second virtual pulse trains.

32. The computing device of claim 29, further comprising:
means for performing dynamic clock and voltage scaling operations that include scaling a frequency or voltage of the first and second processor cores independently when no interdependence relationship is identified between the operations of the first processing core and the operations of the second processing core based on the correlation between the first and second virtual pulse trains.

33. The computing device of claim 29, further comprising:
means for generating predicted processor workloads that account for all available processing resources, including both online and offline processors, based on the correlation between the first and second virtual pulse trains.

34. The computing device of claim 33, wherein means for generating predicted processor workloads comprises means for predicting an operating load under which an offline processor would be if the offline processor were online.

35. The computing device of claim 33, further comprising:
means for determining whether an optimal number of processing resources are currently in use by the computing device; and
means for determining if one or more online processors should be taken offline in response to determining that the optimal number of processing resources are not currently in use.

36. The computing device of claim 35, further comprising:
means for reducing a frequency of the first or second processor to zero in response to determining that one or more online processors should be taken offline.

37. The computing device of claim 33, further comprising:
means for determining if an optimal number of processing resources are currently in use by the computing device; and
means for determining if one or more offline processors should be brought online in response to determining that the optimal number of processing resources are not currently in use.

38. The computing device of claim 37, further comprising:
means for determining an optimal operating frequency at which an offline processor should be brought online based on the predicted workloads in response to determining one or more offline processors should be brought online.

39. The computing device of claim 29, further comprising means for synchronizing the first and second virtual pulse trains in time.

40. The computing device of claim 39, further comprising means for correlating the synchronized first and second virtual pulse trains by overlaying the first virtual pulse train on the second virtual pulse train.

41. The computing device of claim 40, further comprising means for performing dynamic clock and voltage scaling operations on a single thread executing on a processor of the computing device.

42. The computing device of claim 40, wherein means for correlating the synchronized first and second information sets comprises means for producing a consolidated pulse train for each of the first and the second processing cores.

43. A non-transitory processor-readable storage medium having stored thereon processor-executable software instructions configured to cause a processor to perform operations for improving performance on a multiprocessor system having two or more processing cores, the operations comprising:
accessing an operating system run queue to generate a first virtual pulse train for a first processing core and a second virtual pulse train for a second processing core; and
correlating the first and second virtual pulse trains to identify an interdependence relationship between the operations of the first processing core and the operations of the second processing core.

44. The non-transitory processor-readable storage medium of claim 43, wherein the stored processor-executable software instructions are configured to cause a processor to perform operations further comprising:
scheduling threads on the first and second processor cores based on the interdependence relationship between the operations of the first processing core and the operations of the second processing core.

45. The non-transitory processor-readable storage medium of claim 43, wherein the stored processor-executable software instructions are configured to cause a processor to perform operations further comprising:
performing dynamic clock and voltage scaling operations that include scaling a frequency or voltage of the first and second processor cores according to a correlated information set when an interdependence relationship is identified between the operations of the first processing core and the operations of the second processing core based on the correlation between the first and second virtual pulse trains.

46. The non-transitory processor-readable storage medium of claim 43, wherein the stored processor-executable software instructions are configured to cause a processor to perform operations further comprising:
performing dynamic clock and voltage scaling operations that include scaling a frequency or voltage of the first and second processor cores independently when no interdependence relationship is identified between the operations of the first processing core and the operations of the second processing core based on the correlation between the first and second virtual pulse trains.

47. The non-transitory processor-readable storage medium of claim 43, wherein the stored processor-executable software instructions are configured to cause a processor to perform operations further comprising:
generating predicted processor workloads that account for all available processing resources, including both online and offline processors, based on the correlation between the first and second virtual pulse trains.

48. The non-transitory processor-readable storage medium of claim 47, wherein the stored processor-executable software instructions are configured to cause at least one processor core to perform operations such that generating predicted processor workloads comprises predicting an operating load under which an offline processor would be if the offline processor were online.

49. The non-transitory processor-readable storage medium of claim 47, wherein the stored processor-executable software instructions are configured to cause a processor to perform operations further comprising:
determining whether an optimal number of processing resources are currently in use by the multiprocessor system; and
determining if one or more online processors should be taken offline in response to determining that the optimal number of processing resources are not currently in use.

50. The non-transitory processor-readable storage medium of claim 49, wherein the stored processor-executable software instructions are configured to cause a processor to perform operations further comprising:
reducing a frequency of the first or second processor to zero in response to determining that one or more online processors should be taken offline.

51. The non-transitory processor-readable storage medium of claim 47, wherein the stored processor-executable software instructions are configured to cause a processor to perform operations further comprising:
determining if an optimal number of processing resources are currently in use by the multiprocessor system; and
determining if one or more offline processors should be brought online in response to determining that the optimal number of processing resources are not currently in use.

52. The non-transitory processor-readable storage medium of claim 51, wherein the stored processor-executable software instructions are configured to cause a processor to perform operations further comprising:
determining an optimal operating frequency at which an offline processor should be brought online based on the predicted workloads in response to determining one or more offline processors should be brought online.

53. The non-transitory processor-readable storage medium of claim 43, wherein the stored processor-executable software instructions are configured to cause a processor to perform operations further comprising synchronizing the first and second virtual pulse trains in time.

54. The non-transitory processor-readable storage medium of claim 53, wherein the stored processor-executable software instructions are configured to cause a processor to perform operations further comprising correlating the synchronized first and second virtual pulse trains by overlaying the first virtual pulse train on the second virtual pulse train.

55. The non-transitory processor-readable storage medium of claim 54, wherein the stored processor-executable software instructions are configured to cause at least one processor core to perform operations such that a single thread executing on the multiprocessor system performs dynamic clock and voltage scaling operations.

56. The non-transitory processor-readable storage medium of claim 54, wherein the stored processor-executable software instructions are configured to cause at least one processor core to perform operations such that correlating the synchronized first and second information sets comprises producing a consolidated pulse train for each of the first and the second processing cores.
